(19) United States
(12) Patent Application Publication
(10) Pub. No.: US 2017/0308194 A1
(43) Pub. Date: Oct. 26, 2017

(54) Touch Sensor Mesh Designs

(71) Applicant: Atmel Corporation, San Jose, CA (US)

(72) Inventor: David Brent Guard, Southampton (GB)

(21) Appl. No.: 15/134,044

(22) Filed: Apr. 20, 2016

(51) Int. Cl. G06F 3/044; G09G 5/02

(52) U.S. Cl. CPC G06F 3/044; G09G 5/02; G06F 2203/04112; G09G 2300/0452

(57) ABSTRACT

In one embodiment, an apparatus comprises a first conductive layer of a touch sensor comprising a mesh of conductive lines coupled to a substrate. The mesh comprises two periodic series of conductive lines comprising a first and second plurality of conductive lines that intersect. Additionally, a first conductive line and an adjacent second conductive line of the first plurality of conductive lines comprise: an at least bi-chromatic conductive line that covers at least a portion of two sub-pixel colors of a plurality of sub-pixel colors of a plurality of sub-pixels of an alternating pixel display, the plurality of sub-pixels being arranged according to an alternating pixel display pattern, each sub-pixel corresponding to a particular sub-pixel color of the plurality of sub-pixel colors; and another conductive line that, collectively with the at least bi-chromatic line, cover at least a portion of each sub-pixel color.

### TECHNICAL FIELD

The present disclosure relates generally to touch sensors.

### BACKGROUND

According to an example scenario, a touch sensor detects the presence and position of an object (e.g., a user's finger or a stylus) within a touch-sensitive area of touch sensor array overlaid on a display screen, for example. In a touch-sensitive-display application, a touch sensor array allows a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other device. A control panel on a household or other appliance may include a touch sensor.

There are a number of different types of touch sensors, such as for example resistive touch sensors, surface acoustic wave touch sensors, and capacitive touch sensors. In one example, when an object physically touches a touch screen within a touch sensitive area of a touch sensor of the touch screen (e.g., by physically touching a cover layer overlaying a touch sensor array of the touch sensor) or comes within a detection distance of the touch sensor (e.g., by hovering above the cover layer overlaying the touch sensor array of the touch sensor), a change in capacitance may occur within the touch screen at a position of the touch sensor of the touch screen that corresponds to the position of the object within the touch sensitive area of the touch sensor. A touch sensor controller processes the change in capacitance to determine the position of the change of capacitance within the touch sensor (e.g., within a touch sensor array of the touch sensor).

### BRIEF DESCRIPTION OF EXAMPLE EMBODIMENTS

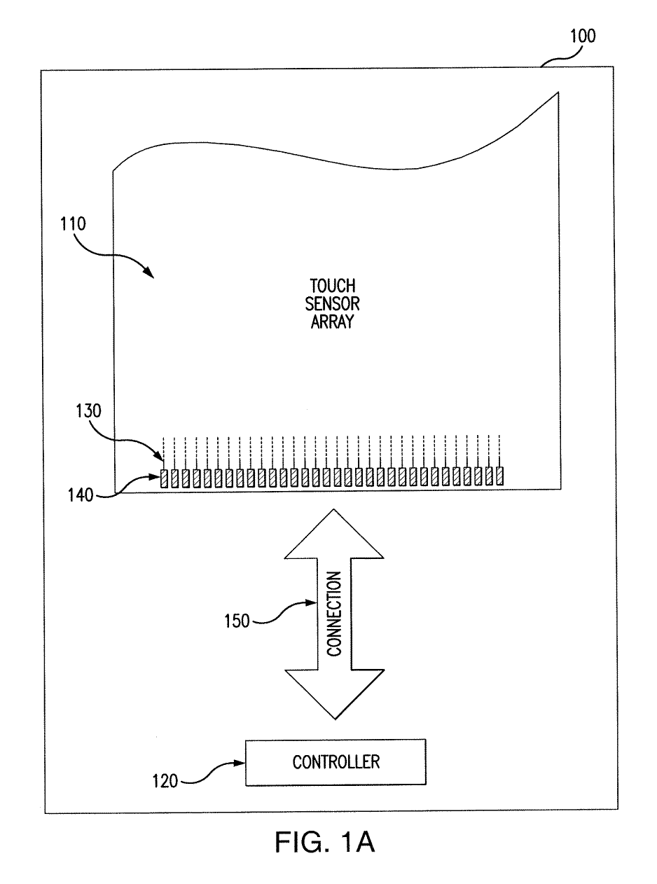

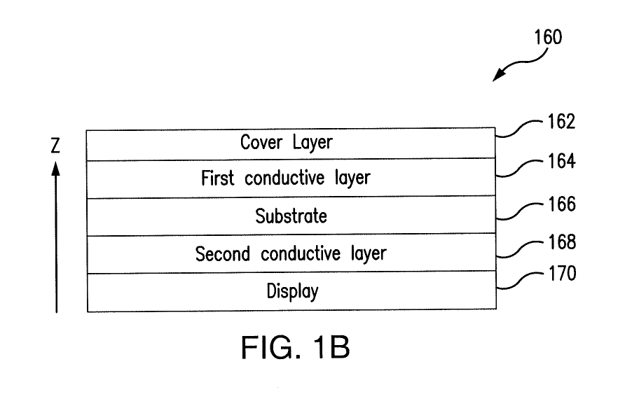

FIG. 1A illustrates an example touch sensor with an example touch sensor controller, according to an embodiment of the present disclosure.

FIG. 1B illustrates an example mechanical stack for a touch sensor, according to an embodiment of the present disclosure.

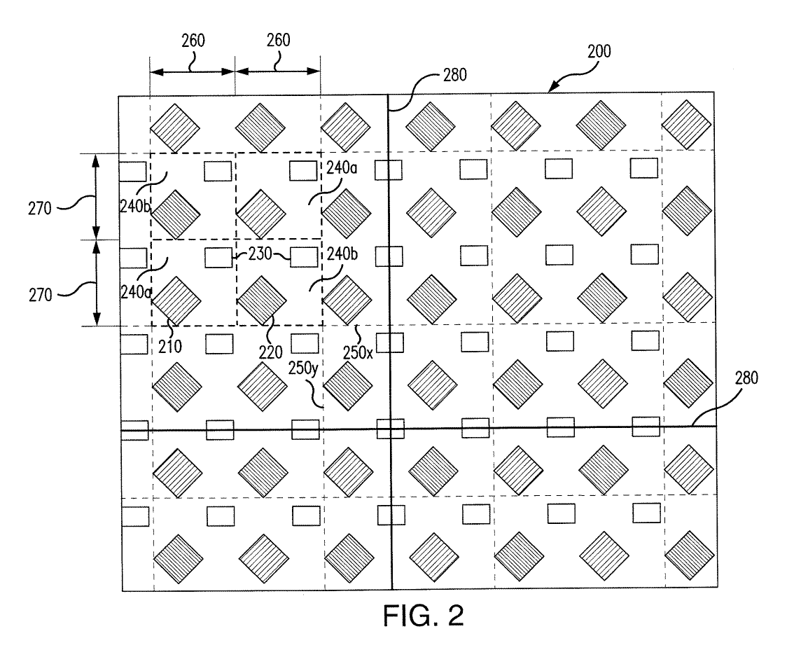

FIG. 2 illustrates an example portion of an example alternating pixel display that includes example pixels and sub-pixels, with example mono-chromatic conductive lines overlying the example portion of an example alternating pixel display, according to an embodiment of the present disclosure.

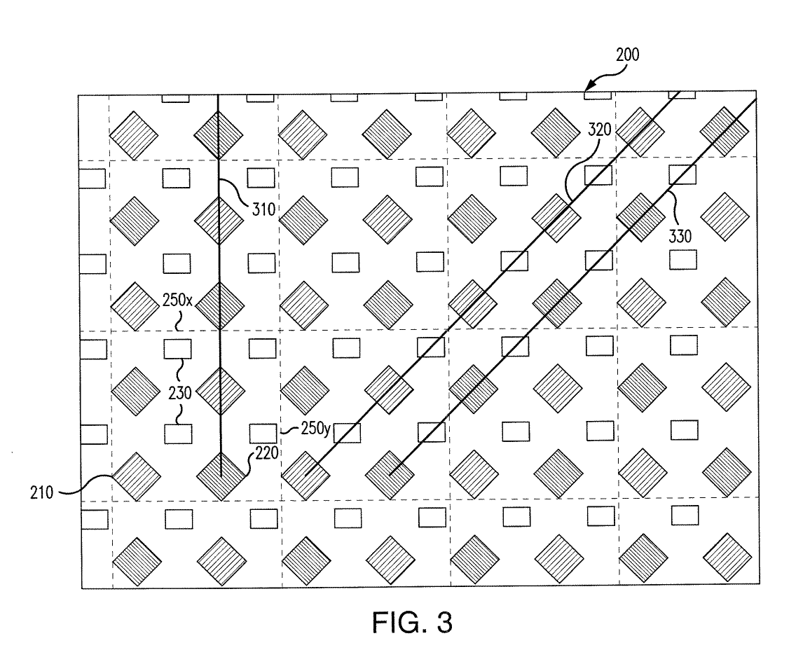

FIG. 3 illustrates an example portion of an example alternating pixel display that includes example pixels and sub-pixels, with example bi-chromatic conductive lines overlying the example portion of an example alternating pixel display, according to an embodiment of the present disclosure.

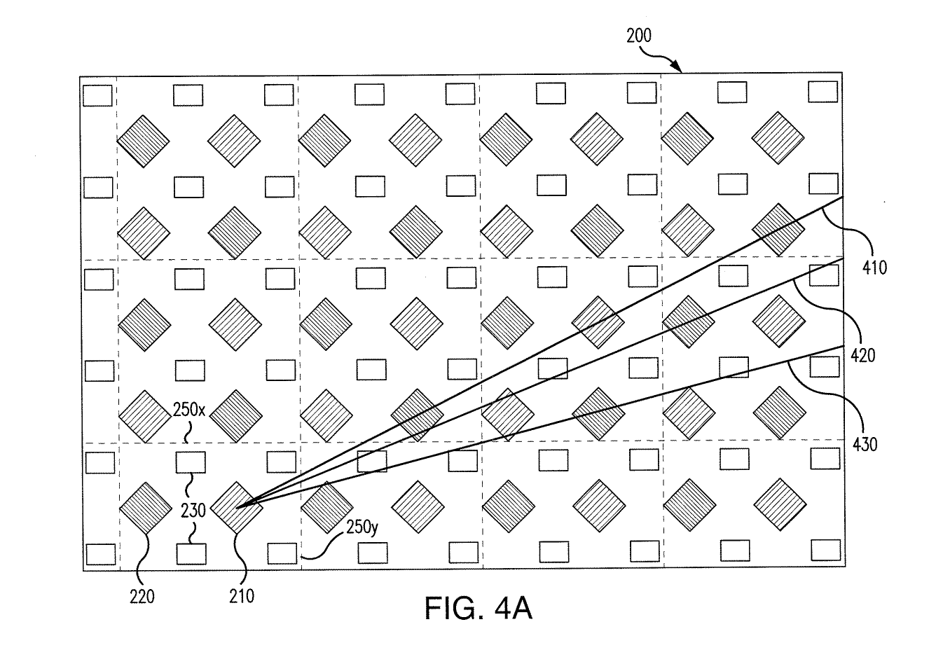

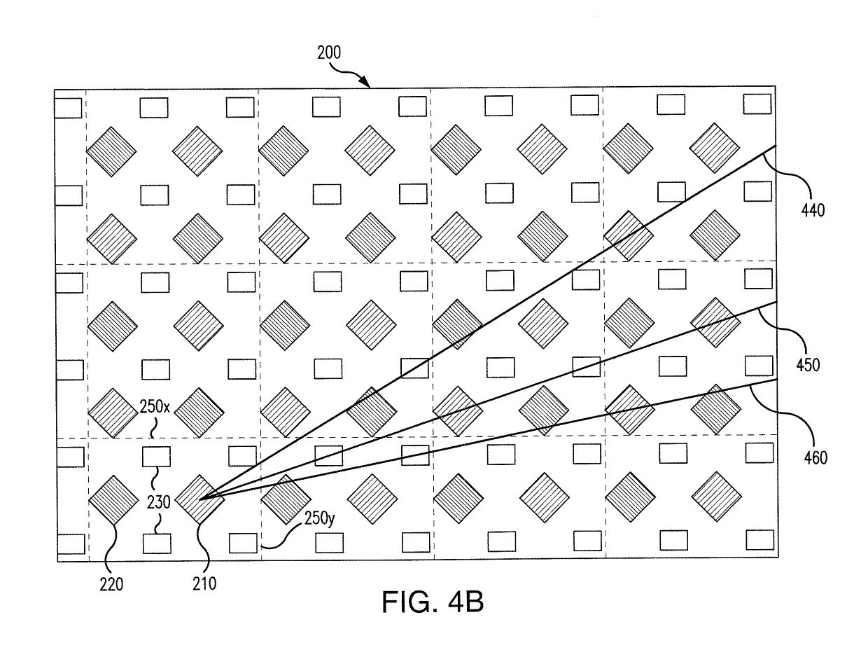

FIGS. 4A and 4B illustrate an example portion of an example alternating pixel display that includes example pixels and sub-pixels, with example pseudo-chromatic conductive lines overlying the example portion of an example alternating pixel display, according to an embodiment of the present disclosure.

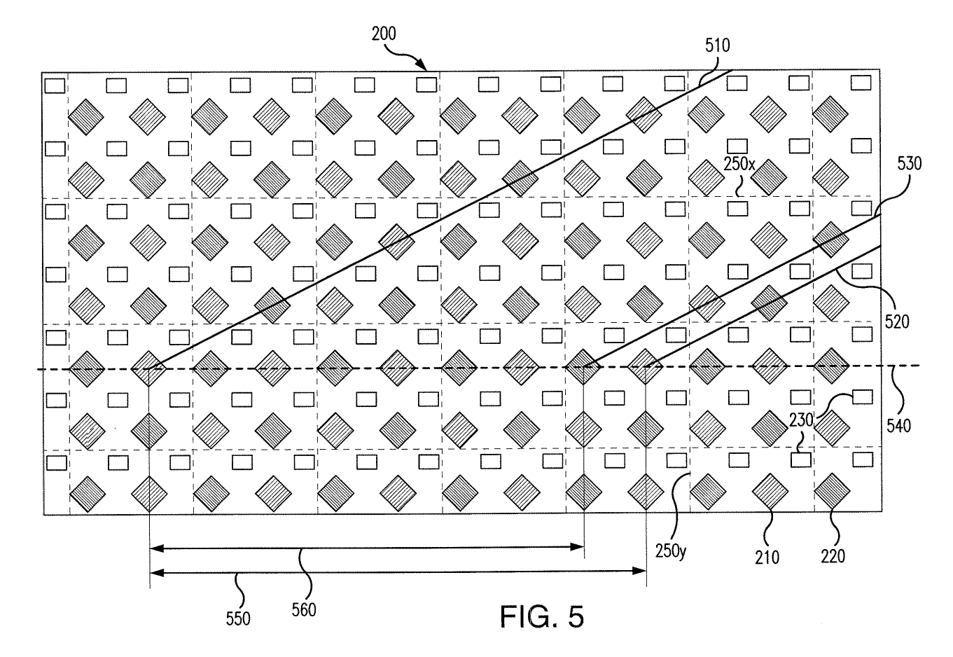

FIG. 5 illustrates an example portion of an example alternating pixel display that includes example pixels and sub-pixels, with an example set of parallel conductive lines overlying the example portion of an example alternating pixel display, according to an embodiment of the present disclosure.

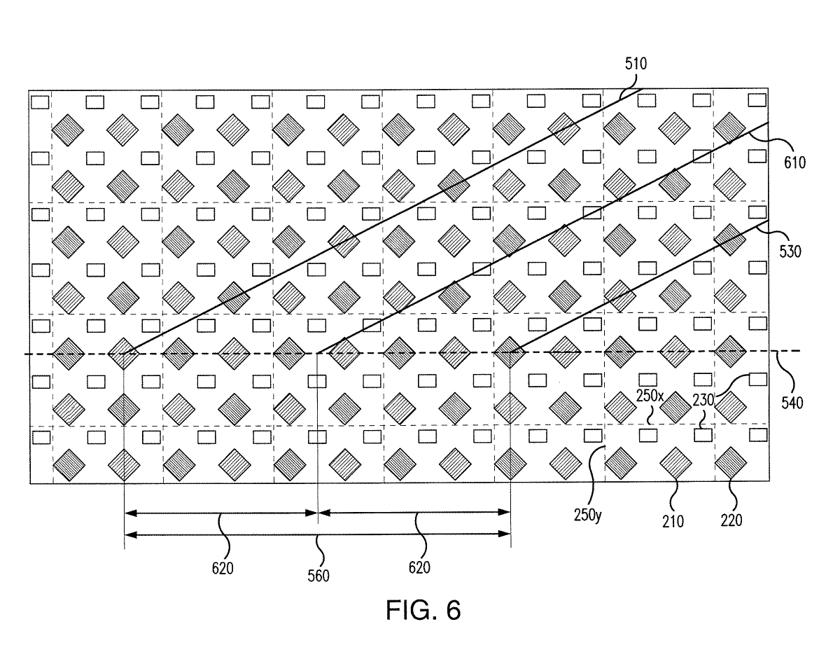

FIG. 6 illustrates an example portion of an example alternating pixel display that includes example pixels and sub-pixels, with an example set of parallel conductive lines overlying the example portion of an example alternating pixel display, according to an embodiment of the present disclosure.

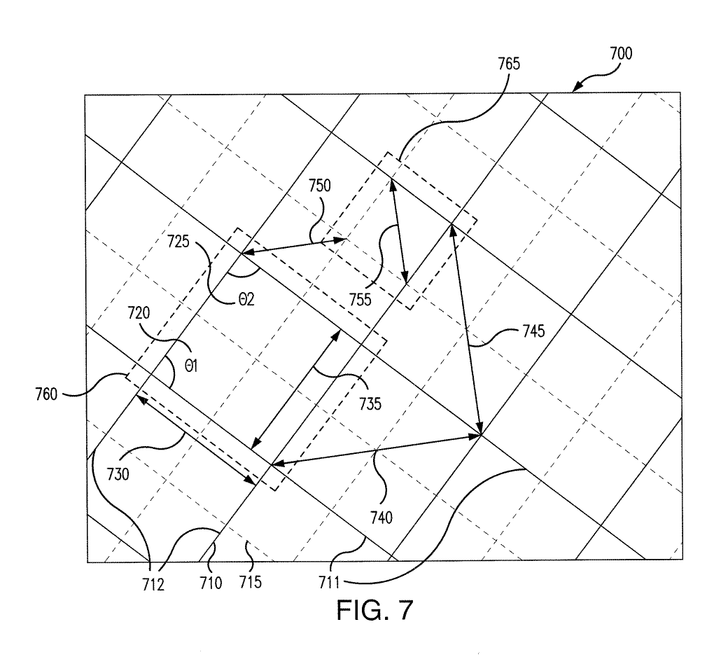

FIG. 7 illustrates an example portion of a dual-layer mesh, where each example mesh layer includes two intersecting sets of parallel conductive lines, according to an embodiment of the disclosure.

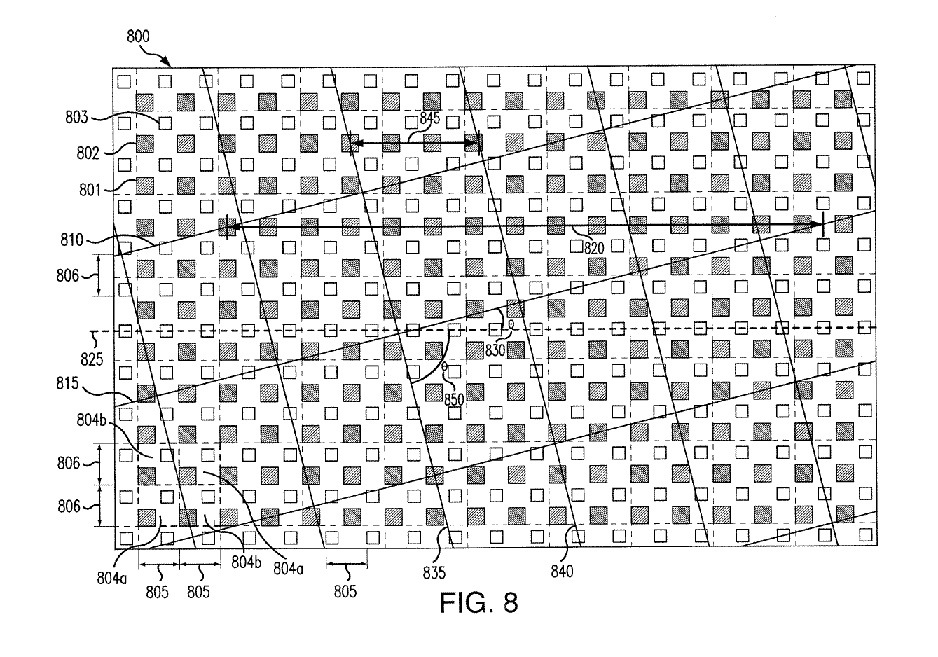

FIG. 8 illustrates an example portion of an example alternating pixel display that includes example pixels and sub-pixels, with a first example set of parallel conductive lines intersecting with a second example set of parallel conductive lines to form a mesh overlying the example portion of an example alternating pixel display, according to an embodiment of the present disclosure.

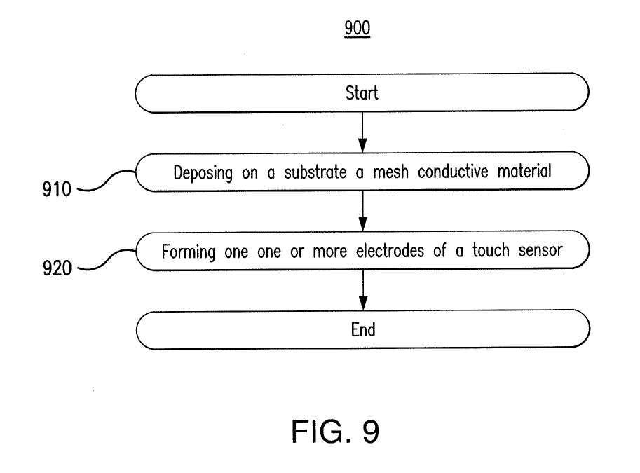

FIG. 9 illustrates an example method for forming one or more electrodes of a touch sensor, according to an embodiment of the present disclosure.

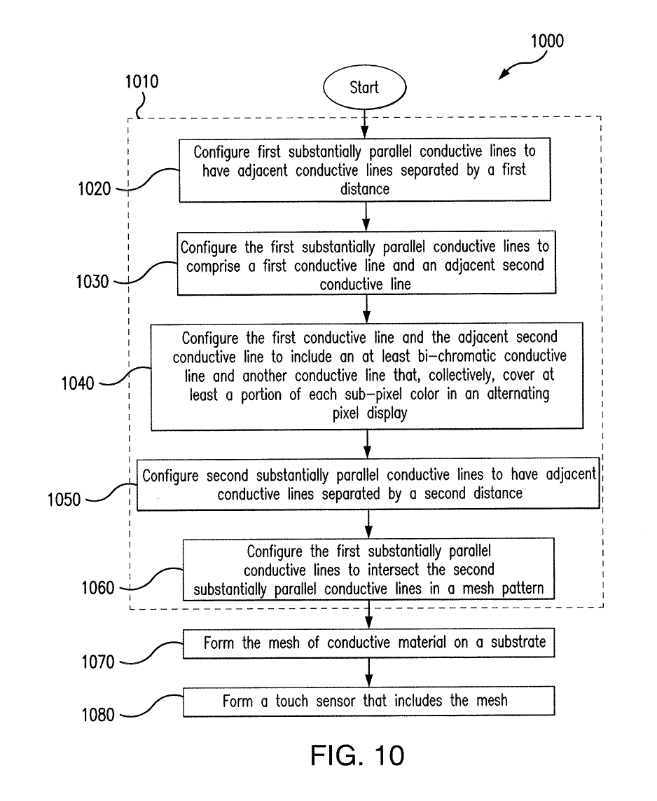

FIG. 10 illustrates an example method for forming one or more touch sensors having one or more meshes, according to an embodiment of the present disclosure.

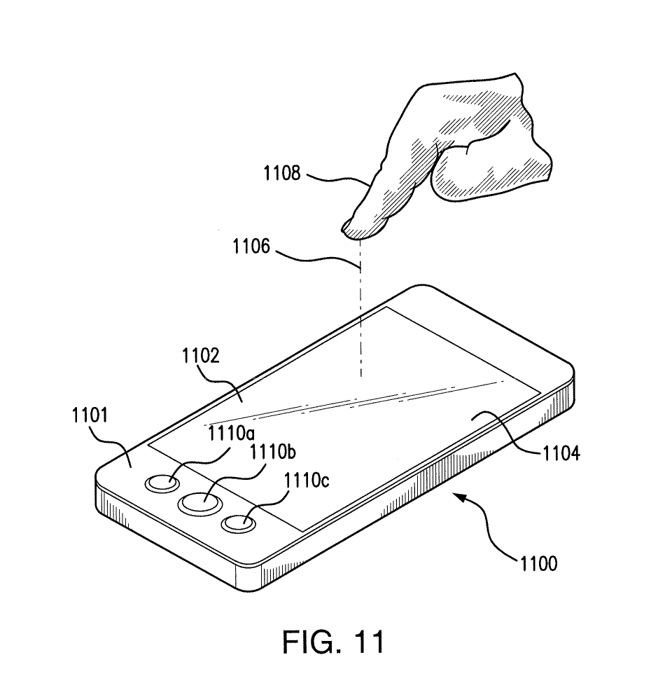

FIG. 11 illustrates an example computer system, according to an embodiment of the present disclosure.

### DESCRIPTION OF EXAMPLE EMBODIMENTS

An embodiment of the present disclosure is directed to reducing or eliminating the appearance of one or more moiré-pattern effects resulting from the optical interaction of mesh pattern touch sensors and optical display devices. In one example, a moiré pattern refers to a secondary and visually evident superimposed pattern that can result from a touch sensor repeated/periodic mesh pattern being overlaid over a repeating pixel pattern of a display. The appearance of a moiré-pattern effect may be caused by one or more features of a touch sensor array, examples of which are described below, that cause perceivable differences in the intensity of light and color from the display.

In one example, a touch sensor mesh pattern, at least in part, changes the intensity of perceivable light and color of a display and thereby causes a moiré-pattern effect to appear when the touch sensor and display are used in combination. More specifically, a mesh pattern including a repeating pattern of conductive lines that are superimposed onto a repeating pattern of pixels or sub-pixels of the display (as shown, for example, in the alternating pixel display portion and conductive lines shown in FIG. 6, and the mesh patterns of conductive lines shown in FIG. 7), and, in one example, the superimposition of the mesh pattern on the display, results in various conductive lines of the mesh pattern passing over and/or through at least some portion of one or more sub-pixels of the display.

The display can have various arrangements or layouts of sub-pixels, such as an arrangement of sub-pixels found in an alternating pixel display, for example. The superimposition of conductive lines, including opaque or semi-opaque materials for example, over the display elements can obstruct or occlude some or all light from the sub-pixels beneath the conductive lines. When the mesh pattern and the pixels of the display are constructed according to regular patterns, for example, the pattern of obstructed (occluded) light caused by the conductive lines covering (which may include intersecting) display elements (e.g., sub-pixels) can result in a visible and/or noticeable pattern to a user viewing the display. To illustrate, particular pixels or sub-pixels may be covered by longer and/or shorter sections of the conductive lines, which can result in particular pixels or sub-pixels covered by shorter lengths of conductive lines resulting in less occlusion (i.e., the pixel or sub-pixel will be brighter), while other pixels or sub-pixels are intersected by longer sections of the conductive lines resulting in more occlusion (i.e., the pixels or sub-pixels will be dimmer). In one example, the repeating nature of conductive lines and pixels results in particular frequencies associated with the pixels having similar occlusion levels.

An embodiment of the present disclosure recognizes that the naked eye is capable of discerning particular low frequency moiré patterns better than high frequency moiré patterns. An embodiment of the present disclosure relates to construction of the mesh pattern and alignment of the mesh pattern with the underlying display elements (e.g., pixels and sub-pixels) such that low frequency moiré effects are reduced or eliminated.

In one example, alternating pixel displays have sub-pixel layouts or display patterns that differ from, for example, standard RGB sub-pixel layouts. In an embodiment, alternating pixel displays have an alternating pixel display pattern where each pixel contains a number of sub-pixels that is less than the number of sub-pixel colors in the alternating pixel display, and where whichever sub-pixel color(s) are missing from one pixel are present in the adjacent pixel. For example, in an embodiment, an alternating pixel display has (or is arranged according to) an example alternating pixel display pattern having three sub-pixel colors: red, green, and blue. In this example, each pixel includes two sub-pixels of different colors, and adjacent pixels alternate the color of one sub-pixel, such that one sub-pixel color alternates between adjacent pixels, and one sub-pixel color is constant among all pixels. For example, the pixels of an alternating pixel display may include a green sub-pixel and either a red or a blue sub-pixel, such that the green sub-pixel is present in all (or nearly all) sub-pixels, the red sub-pixel is present in about half of the pixels, the blue sub-pixel is present in the other about half of the pixels, and adjacent pixels alternate between including a red sub-pixel (along with a green sub-pixel) and a blue sub-pixel (along with a green sub-pixel). In an embodiment, this may be referred to as an RGBG display or display pattern. Thus, in this example, an alternating pixel display pattern contains about twice as many of one sub-pixel color than the other sub-pixel colors (e.g., twice as many green sub-pixels as red or blue sub-pixels). This disclosure contemplates alternating pixel displays having other sub-pixel color arrangements within pixels, a different number of sub-pixels in each pixel, other sub-pixel colors, and other arrangement of pixels.

As another example, in an embodiment, an alternating pixel display has an example alternating pixel display pattern having four sub-pixel colors: red, green, blue, and white. For example, each pixel includes two sub-pixels of different colors, and adjacent pixels include the remaining two sub-pixel colors. For example, an alternating pixel display may contain adjacent pixels that alternate between pixels having red and green sub-pixels and pixels having blue and white sub-pixels. In an embodiment, this may be referred to as an RGBW display or display pattern. This disclosure contemplates alternating pixel displays having other sub-pixel color arrangements within pixels, a different number of sub-pixels in each pixel (e.g., three sub-pixels per pixel), other sub-pixel colors, and other arrangement of pixels.

In an embodiment, an alternating pixel display may be a PenTile display. In an embodiment, the relative sizes of the subpixels are not the same. For example, the size of the constant sub-pixel color (e.g., the green sub-pixel color) may be smaller than the size of the alternating sub-pixel colors, such that, for example, the total area of each sub-pixel color over a given portion of an alternating pixel display is substantially equal. In an embodiment, other alternating pixel display patterns are used, including, for example, display patterns using different sub-pixel alternation patterns and/or relative sub-pixel orientations. In other example embodiments, an example alternating pixel display can have fewer or more sub-pixel colors, fewer or more sub-pixels in each pixel, fewer or more constant and/or alternating sub-pixel colors in each sub-pixel, and the sub-pixels can have the same or different relative shapes and/or orientations to one another.

An embodiment of the present disclosure recognizes that any one example conductive line in a mesh pattern can cover (and occlude), for example, a portion of one, two, or all three sub-pixel colors of a display having a three-color alternating pixel display pattern (fewer or more sub-pixel colors can be covered or occluded when alternating pixel displays having fewer or more sub-pixel colors are used). In an embodiment, a conductive line that covers or occludes part of one or more sub-pixels of a particular color, but does not cover or occlude any sub-pixels of a different color, is referred to as a “mono-chromatic” conductive line. In an embodiment, a conductive line that covers or occludes part of one or more sub-pixels of a first color as well as part of one or more sub-pixels of a second color, but does not cover or occlude any sub-pixels of a color that is different than the first and second colors, is referred to as a “bi-chromatic” conductive line. In an embodiment, a conductive line that covers or occludes part of one or more sub-pixels of a first color, part of one or more sub-pixels of a second color, as well as part of one or more sub-pixels of a third color, but does not cover or occlude any sub-pixels of a color that is different than the first, second and third colors, is referred to as a “trichromatic” conductive line, etc. In an embodiment, a conductive line that covers or occludes part of sub-pixels respectively having all of the sub-pixel colors present on a particular alternating pixel display (a display having an alternating pixel display pattern) is referred to as a “pseudo-chromatic” conductive line. In an embodiment, meshes including pseudo-chromatic conductive lines may be more effective at reducing or eliminating certain moiré effects than meshes including only mono-chromatic, bi-chromatic and/or tri-chromatic conductive lines.

In an embodiment, mesh patterns (e.g., mesh geometries) that have a more equal occlusion of all the different sub-pixel colors of a display (e.g., an alternating pixel display having red, green, and blue sub-pixels) may be more effective at reducing or eliminating certain moiré effects than mesh patterns that have a less equal occlusion of all the different sub-pixel colors. In an embodiment, mesh patterns (e.g., mesh geometries) that have a more equal occlusion of all the different sub-pixel colors of a display (e.g., an alternating pixel display having red, green, and blue sub-pixels) over shorter periods (e.g., shorter distances for the conductive lines of a mesh to collectively occlude equal, or substantially equal, portions of each sub-pixel color) may be more effective at reducing or eliminating certain moiré effects than mesh patterns that have a more equal occlusion of all the different sub-pixel colors but over longer periods. In example embodiments, the period (or distance) required for the conductive lines of a mesh to collectively occlude equal, or substantially equal, portions of each sub-pixel color may be known as the integration period or integration distance. In an example embodiment, meshes with more even occlusion of all the different sub-pixel colors over a shorter period be more effective at reducing or eliminating certain moiré effects than meshes with a longer period.

An embodiment of the present disclosure relates to designing mesh patterns that account for the patterns of sub-pixels found in alternating pixel displays, such that the mesh patterns occlude light in way that reduces or eliminates the frequency moiré patterns while preserving optical performance and touch sensor performance. In an embodiment of the present disclosure, conductive lines of a touch sensor are adapted to occlude light from each sub-pixel color in a given alternating pixel display, for example, by using pseudo-chromatic conductive lines. In one example, using pseudo-chromatic conductive lines (or a combination of non-pseudo-chromatic lines) occludes light from each sub-pixel color in an alternating pixel display, which may allow for attenuation of low frequency moiré patterns that can exist without the use of such conductive lines. Using pseudo-chromatic conductive lines (or a combination of non-pseudo-chromatic lines) in some portions the touch sensor (e.g., in some sets of parallel conductive lines) may allow for other sets of the conductive lines to remain non-pseudo-chromatic. In an embodiment, these techniques allow for improved color integration and mitigation of low frequency moiré patterns.

In one embodiment, an apparatus comprises a first conductive layer of a touch sensor comprising a mesh of conductive lines coupled to a substrate. The mesh comprises two periodic series of conductive lines comprising a first and second plurality of conductive lines that intersect. Additionally, a first conductive line and an adjacent second conductive line of the first plurality of conductive lines comprise: an at least bi-chromatic conductive line that covers at least a portion of two sub-pixel colors of a plurality of sub-pixel colors of a plurality of sub-pixels of an alternating pixel display, the plurality of sub-pixels being arranged according to an alternating pixel display pattern, each sub-pixel corresponding to a particular sub-pixel color of the plurality of sub-pixel colors; and another conductive line that, collectively with the at least bi-chromatic line, cover at least a portion of each sub-pixel color.

FIG. 1A illustrates an example touch sensor 100 with an example touch sensor controller, according to an embodiment of the present disclosure. Touch sensor 100 includes touch sensor array 110 and touch sensor controller 120. Touch sensor array 110 and touch sensor controller 120 detect the presence and position of a touch or the proximity of an object within a touch-sensitive area of touch sensor array 110.

Touch sensor array 110 includes one or more touch-sensitive areas. In one embodiment, touch sensor array 110 includes an array of electrodes disposed on one or more substrates, wherein one or more of such substrates may be made of a dielectric material.

In one embodiment, an electrode is an area of conductive material forming a shape, such as for example a disc, square, rectangle, thin line, other shape, or a combination of these shapes. One or more cuts in one or more layers of conductive material (at least in part) create the shape of an electrode, and the area of the shape is (at least in part) bounded by those cuts. In one embodiment, the conductive material of an electrode occupies approximately 100% of the area of its shape. For example, an electrode may be made of indium tin oxide (ITO) and the ITO of the electrode can occupy approximately 100% of the area of its shape (sometimes referred to as 100% fill). In one embodiment, the conductive material of an electrode occupies less than 100% of the area of its shape. For example, an electrode may be made of fine lines of metal or other conductive material (FLM), such as for example copper, silver, or a copper- or silver-based material, and the fine lines of conductive material may occupy approximately 5% of the area of its shape in a hatched, mesh, or other pattern. Reference to FLM encompasses such material. Although this disclosure describes or illustrates particular electrodes made of particular conductive material forming particular shapes with particular fill percentages having particular patterns, this disclosure contemplates, in any combination, electrodes made of other conductive materials forming other shapes with other fill percentages having other patterns.

The shapes of the electrodes (or other elements) of a touch sensor array 110 constitute, in whole or in part, one or more macro-features of touch sensor array 110. One or more characteristics of the implementation of those shapes (such as, for example, the conductive materials, fills, or patterns within the shapes) constitute in whole or in part one or more micro-features of touch sensor array 110. In an embodiment, one or more macro-features of a touch sensor array 110 determine one or more characteristics of its functionality, and one or more micro-features of touch sensor array 110 determine one or more optical features of touch sensor array 110, such as transmittance, refraction, or reflection.

Although this disclosure describes a number of example electrodes, the present disclosure is not limited to these example electrodes and other electrodes can be implemented. Additionally, although this disclosure describes a number of example embodiments that include particular configurations of particular electrodes forming particular nodes, the present disclosure is not limited to these example embodiments and other configurations can be implemented. In one embodiment, a number of electrodes are disposed on the same or different surfaces of the same substrate. Additionally or alternatively, different electrodes may be disposed on different substrates. Although this disclosure describes a number of example embodiments that include particular electrodes arranged in specific, example patterns, the present disclosure is not limited to these example patterns and other electrode patterns can be implemented.

A mechanical stack contains the substrate (or multiple substrates) and the conductive material forming the electrodes of touch sensor array 110. For example, in an embodiment, the mechanical stack includes a first layer of optically clear adhesive (OCA) beneath a cover panel. The cover panel is, for example, clear (or substantially clear) and made of a resilient material for repeated touching, such as for example glass, polycarbonate, or poly (methyl methacrylate) (PMMA). This disclosure contemplates a cover panel being made of any clear, or substantially clear, material. In an embodiment, the first layer of OCA is disposed between the cover panel and the substrate with the conductive material forming the electrodes. The mechanical stack also includes, for example, a second layer of OCA and a dielectric layer (which is made of PET or another material, similar to the substrate with the conductive material forming the electrodes). As an alternative, a thin coating of a dielectric material may be applied instead of the second layer of OCA and the dielectric layer. The second layer of OCA in an embodiment is disposed between the substrate with the conductive material making up the electrodes and the dielectric layer, and the dielectric layer is disposed between the second layer of OCA and an air gap to a display of a device including touch sensor array 110 and touch sensor controller 120. For example, the cover panel may have a thickness of approximately 1 millimeter (mm); the first layer of OCA may have a thickness of approximately 0.05 mm; the substrate with the conductive material forming the electrodes may have a thickness of approximately 0.05 mm; the second layer of OCA may have a thickness of approximately 0.05 mm; and the dielectric layer may have a thickness of approximately 0.05 mm.

Although this disclosure describes a particular mechanical stack with a particular number of particular layers made of particular materials and having particular thicknesses, this disclosure contemplates other mechanical stacks with any number of layers made of any materials and having any thicknesses. For example, in one embodiment, a layer of adhesive or dielectric replaces the dielectric layer, second layer of OCA, and air gap described above, with there being no air gap in the display.

In an embodiment, one or more portions of the substrate of touch sensor array 110 are made of polyethylene terephthalate (PET) or another material. This disclosure contemplates any substrate with portions made of any material(s). In one embodiment, one or more electrodes in touch sensor array 110 are made of ITO in whole or in part. Additionally or alternatively, one or more electrodes in touch sensor array 110 are made of fine lines of metal or other conductive material. For example, one or more portions of the conductive material may be copper or copper-based and have a thickness of approximately 5 microns (μm) or less and a width of approximately 10 μm or less. As another example, one or more portions of the conductive material may be silver or silver-based and similarly have a thickness of approximately 5 μm or less and a width of approximately 10 μm or less. This disclosure contemplates any electrodes made of any electrically-conductive materials.

In one embodiment, touch sensor array 110 implements a capacitive form of touch sensing. In a mutual-capacitance implementation, touch sensor array 110 includes, for example, an array of drive and sense electrodes forming an array of capacitive nodes. A drive electrode and a sense electrode form a capacitive node. The drive and sense electrodes forming the capacitive node are positioned near each other but do not make electrical contact with each other. Instead, in response to a signal being applied to the drive electrodes for example, the drive and sense electrodes capacitively couple to each other across a space between them. A pulsed or alternating voltage applied to the drive electrode (by touch sensor controller 120) induces a charge on the sense electrode, and the amount of charge induced is susceptible to external influence (such as a touch or the proximity of an object). When an object touches or comes within proximity of the capacitive node, a change in capacitance occurs at the capacitive node and touch sensor controller 120 measures the change in capacitance. By measuring changes in capacitance throughout the array, touch sensor controller 120 determines the position of the touch or proximity within touch-sensitive areas of touch sensor array 110.

In a self-capacitance implementation, touch sensor array 110 includes, for example, an array of electrodes of a single type that may each form a capacitive node. When an object touches or comes within proximity of the capacitive node, a change in self-capacitance may occur at the capacitive node and touch sensor controller 120 measures the change in capacitance, for example, as a change in the amount of charge implemented to raise the voltage at the capacitive node by a predetermined amount. As with a mutual-capacitance implementation, by measuring changes in capacitance throughout the array, touch sensor controller 120 determines the position of the touch or proximity within touch-sensitive areas of touch sensor array 110. This disclosure contemplates any form of capacitive touch sensing.

In one embodiment, one or more drive electrodes together form a drive line running horizontally or vertically or in other orientations. Similarly, in one embodiment, one or more sense electrodes together form a sense line running horizontally or vertically or in other orientations. As one particular example, drive lines run substantially perpendicular to the sense lines. Reference to a drive line may encompass one or more drive electrodes making up the drive line, and vice versa. Reference to a sense line encompasses, for example, one or more sense electrodes making up the sense line, and vice versa.

In one embodiment, touch sensor array 110 includes drive and sense electrodes disposed in a pattern on one side of a single substrate. In such a configuration, a pair of drive and sense electrodes capacitively coupled to each other across a space between them form a capacitive node. As an example self-capacitance implementation, electrodes of a single type are disposed in a pattern on a single substrate. In addition or as an alternative to having drive and sense electrodes disposed in a pattern on one side of a single substrate, touch sensor array 110 may have drive electrodes disposed in a pattern on one side of a substrate and sense electrodes disposed in a pattern on another side of the substrate. Moreover, touch sensor array 110 may have drive electrodes disposed in a pattern on one side of one substrate and sense electrodes disposed in a pattern on one side of another substrate. In such configurations, an intersection of a drive electrode and a sense electrode forms a capacitive node. Such an intersection is a position where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates other configurations of electrodes forming nodes. Moreover, this disclosure contemplates other electrodes disposed on any number of substrates in any patterns.

As described above, in an embodiment, a change in capacitance at a capacitive node of touch sensor array 110 indicates a touch or proximity input at the position of the capacitive node. Touch sensor controller 120 detects and processes the change in capacitance to determine the presence and position of the touch or proximity input. In one embodiment, touch sensor controller 120 then communicates information about the touch or proximity input to one or more other components (such as one or more central processing units (CPUs)) of a device that includes touch sensor array 110 and touch sensor controller 120, which responds to the touch or proximity input by initiating a function of the device (or an application running on the device). Although this disclosure describes a particular touch sensor controller 120 having particular functionality with respect to a particular device and a particular touch sensor 100, this disclosure contemplates other touch sensor controllers having any functionality with respect to any device and any touch sensor.

In one embodiment, touch sensor controller 120 is implemented as one or more integrated circuits (ICs), such as for example general-purpose microprocessors, microcontrollers, programmable logic devices or arrays, application-specific ICs (ASICs). Touch sensor controller 120 includes any combination of analog circuitry, digital logic, and digital non-volatile memory. In one embodiment, touch sensor controller 120 is disposed on a flexible printed circuit (FPC) bonded to the substrate of touch sensor array 110, as described below. The FPC is active or passive. In one embodiment, multiple touch sensor controllers 120 are disposed on the FPC.

In an example implementation, touch sensor controller 120 includes a processor unit, a drive unit, a sense unit, and a storage unit. In such an implementation, the drive unit supplies drive signals to the drive electrodes of touch sensor array 110, and the sense unit senses charge at the capacitive nodes of touch sensor array 110 and provides measurement signals to the processor unit representing capacitances at the capacitive nodes. The processor unit controls the supply of drive signals to the drive electrodes by the drive unit and processes measurement signals from the sense unit to detect and process the presence and position of a touch or proximity input within touch-sensitive areas of touch sensor array 110. In an embodiment, the processor unit also tracks changes in the position of a touch or proximity input within touch-sensitive areas of touch sensor array 110. The storage unit stores programming for execution by the processor unit, including programming for controlling the drive unit to supply drive signals to the drive electrodes, programming for processing measurement signals from the sense unit, and other programming. Although this disclosure describes a particular touch sensor controller 120 having a particular implementation with particular components, this disclosure contemplates touch sensor controller having other implementations with other components.

Tracks 130 of conductive material disposed on the substrate of touch sensor array 110 couple the drive or sense electrodes of touch sensor array 110 to connection pads 140, also disposed on the substrate of touch sensor array 110. As described below, connection pads 140 facilitate coupling of tracks 130 to touch sensor controller 120. Tracks 130 extend into or around (e.g., at the edges of) touch-sensitive areas of touch sensor array 110. In one embodiment, particular tracks 130 provide drive connections for coupling touch sensor controller 120 to drive electrodes of touch sensor array 110, through which the drive unit of touch sensor controller 120 supplies drive signals to the drive electrodes, and other tracks 130 provide sense connections for coupling touch sensor controller 120 to sense electrodes of touch sensor array 110, through which the sense unit of touch sensor controller 120 senses charge at the capacitive nodes of touch sensor array 110.

Tracks 130 are made of fine lines of metal or other conductive material. For example, the conductive material of tracks 130 may be copper or copper-based and have a width of approximately 100 μm or less. As another example, the conductive material of tracks 130 may be silver or silver-based and have a width of approximately 100 μm or less. In one embodiment, tracks 130 are made of ITO in whole or in part in addition or as an alternative to the fine lines of metal or other conductive material. Although this disclosure describes particular tracks made of particular materials with particular widths, this disclosure contemplates tracks made of other materials and/or other widths. In addition to tracks 130, in an embodiment, touch sensor array 110 includes one or more ground lines terminating at a ground connector (which can be a connection pad 140) at an edge of the substrate of touch sensor array 110 (similar to tracks 130).

Connection pads 140, in an embodiment, are located along one or more edges of the substrate, outside a touch-sensitive area of touch sensor array 110. As described above, in an embodiment, touch sensor controller 120 is on an FPC. Connection pads 140 are, for example, made of the same material as tracks 130 and are bonded to the FPC using an anisotropic conductive film (ACF). In one embodiment, connection 150 includes conductive lines on the FPC coupling touch sensor controller 120 to connection pads 140, in turn coupling touch sensor controller 120 to tracks 130 and to the drive or sense electrodes of touch sensor array 110. In another embodiment, connection pads 140 are connected to an electro-mechanical connector (such as, for example, a zero insertion force wire-to-board connector). Connection 150 can include an FPC. This disclosure contemplates any connection 150 between touch sensor controller 120 and touch sensor array 110.

FIG. 1B illustrates an example dual-layer mechanical stack 160 for a touch sensor 100, according to an embodiment of the present disclosure. In the example embodiment of FIG. 1B, the mechanical stack 160 includes multiple layers and is illustrated as positioned with respect to a z-axis. The example mechanical stack 160 includes a display 170 (e.g., a display portion 200 of FIG. 2 or 800 of FIG. 8), a second conductive layer 168, a substrate 166, a first conductive layer 164, and a cover layer 162. In an embodiment, the second conductive layer 168 and first conductive layer 164 are drive and sense electrodes, respectively, as discussed above in connection with FIG. 1A. In an embodiment, the second conductive layer 168 and first conductive layer 164 are meshes as described in this disclosure. Substrate 166 comprises, in an embodiment, a material which electrically isolates the first and second conductive layers. In an embodiment, substrate 166 provides mechanical support for other layers. In an embodiment, additional layers of substrate (which, for example, may not be the same material as substrate 166) may be used in different configurations. For example, a second substrate layer may be located between second conductive layer 168 and display 170. The display 170 provides display information to be viewed by a user. In an embodiment, display 170 may be an alternating pixel display having subpixels arranged in an alternating pixel display pattern. Cover layer 162 may be clear, or substantially clear, and made of a resilient material for repeated touching, such as for example glass, polycarbonate, or poly(methyl methacrylate) (PMMA). In an embodiment, a transparent or semi-transparent adhesive layer is placed between cover layer 19A and first conductive layer 19B, and/or between second conductive layer 19D and display 19E. A user may interact with touch sensor 100 by touching cover layer 162 using a finger or some other touch object (such as a stylus). A user may also interact with touch sensor 100 by hovering a finger or some other touch object over cover layer 162 without actually making physical contact with cover layer 162. In the example embodiment of FIG. 1B, mechanical stack 19 comprises two conductive layers forming, for example, a dual-layer mesh. In an embodiment, mechanical stack 19 may comprise a single conductive layer forming, for example, a single-layer mesh. Other embodiments of mechanical stack 160 may implement other configurations, relations, and perspectives, as well as fewer or additional layers.

In an embodiment, mechanical stack 19 comprises a combination of conductive mesh and ITO layers, where, for example, one of first conductive layer 19B and second conductive layer 19D is a conductive layer mesh, and the other is ITO. In this embodiment, the conductive layer mesh acts as a single-layer mesh, and, in an embodiment, the ITO layer may transmit and/or receive signals. In this embodiment, only one layer, for example the conductive mesh layer, may be modulated according to this disclosure (as discussed in more detail below).

FIG. 2 illustrates an example portion 200 of an example alternating pixel display that includes example pixels 240 (e.g., 240a and 240b) and sub-pixels (e.g., 210, 220, 230), with example mono-chromatic conductive lines 280 overlying the example portion 200 of an example alternating pixel display, according to an embodiment of the present disclosure. In an embodiment, the elements of an example alternating pixel display can be described in relation to horizontal gridlines (or axes) 250x and vertical gridlines (or axes) 250y. In one embodiment, a touch sensor is overlaid on the display to implement a touch-sensitive display device. As an example, the display underneath the touch sensor may be a liquid crystal display (LCD), a light-emitting diode (LED) display, an organic LED display, an LED backlight LCD, an electrophoretic display, a plasma display, or other display. Although this disclosure describes and illustrates particular display types, this disclosure contemplates any other display types.

Portion 200 includes an array of pixels 240. In the example of FIG. 2, each pixel 240 includes two sub-pixels (e.g., 210, 220, and/or 230). In an embodiment, each sub-pixel (e.g., 210, 220, and/or 230) corresponds to a particular color, such as for example red, green, or blue. In an embodiment, one or more sub-pixels correspond to other colors, such as white (or no color). For example, each sub-pixel is configured to emit light having a wavelength associated with a particular color. In the example of FIG. 2, each pixel 240 includes two sub-pixels: either a red sub-pixel 210 and green sub-pixel 230 (which together form pixel 240a), or a blue sub-pixel 220 and a green sub-pixel 230 (which together form pixel 240b). In an embodiment, one sub-pixel color is present in all or nearly all pixels 240. For example, all pixels 240, including both pixels 240a and pixels 240b contain a green sub-pixel 230 (the green sub-pixel 230 is constant across all or nearly all sub-pixels). This disclosure also contemplates other constant sub-pixels having other colors. In an embodiment, certain sub-pixels are not constant across all or nearly all sub-pixels. For example, about half of the pixels (e.g., pixels 240a) of alternating pixel display portion 200 can contain a red subpixel 210, and about the other about half of the pixels (e.g., pixels 240b) of the alternating pixel display portion 200 can contain a blue sub-pixel 220. In an embodiment, a row of pixels 240 may alternate between pixels 240a and 240b. In an embodiment, a column of pixels 240 may alternate between pixels 240a and 240b. In an embodiment, each pixel 240a and 240b are laid out in a pattern such that any pixel 240a does not share an entire face with another pixel 240a, and any pixel 240b does not share a face with another pixel 240b. This disclosure contemplates other layouts and patterns of pixels having different combinations, arrangements, and shapes of sub-pixels. As an example, one or more pixels can include a sub-pixel having a different color, such as white (or no color), for example, in an RGBW display.

The area of a pixel 240a is indicated by the dashed-line border that encompasses sub-pixels 210 and 230 in FIG. 2, where each sub-pixel corresponds, in one example, to the color red and green, respectively. The combined output of sub-pixels 210 and 230 determines the color and intensity of each pixel 240a. The area of a pixel 240b is indicated by the dashed-line border that encompasses sub-pixels 220 and 230 in FIG. 2, where each sub-pixel corresponds, in one example, to the color blue and green, respectively. The combined output of sub-pixels 220 and 230 determines the color and intensity of each pixel 240b. The combined output of pixels 240a and 240b determines the color and intensity of light including, for example, all sub-pixel colors (e.g., one red sub-pixel 210, one blue sub-pixel 220, and two green sub-pixels 230). Each pixel 240 has a width (or horizontal distance) that may be known as a horizontal pixel pitch 260, and a height (or vertical distance) that may be known as a vertical pixel pitch 270. In an embodiment that includes an alternating pixel display, such as the embodiment of FIG. 2, the horizontal pixel pitch 260 and vertical pixel pitch 270 are the same as the horizontal sub-pixel pitch and vertical sub-pixel pitch, respectively. In an embodiment, the length of horizontal pixel pitch 260 is the same as the length of vertical pixel pitch 270. Although FIG. 2 describes pixels 240a and 240b having the same horizontal dimensions (horizontal pixel pitch 260) and the same vertical dimensions (vertical pixel pitch 270), and the same areas, this disclosure contemplates different pixels having different dimensions and different areas from one another. In addition, although this disclosure describes and illustrates example pixels 240 (e.g., 240a and 240b) with a particular number of sub-pixels (e.g., 210, 220, and 230) having particular colors and shapes, this disclosure contemplates other pixels with other numbers of sub-pixels having other colors and shapes.

FIG. 2 also illustrates example mono-chromatic conductive lines 280 overlying the example portion 200 of an example alternating pixel display, according to an embodiment of the present disclosure. In an example embodiment, conductive lines 280 form respective parts of a mesh pattern of an electrode of a touch sensor. In an embodiment, an arrangement of conductive lines that form at least part of a touch sensor are referred to as a mesh, mesh pattern, or mesh design (e.g., a single, dual, or multi-layer mesh of a touch-sensor). Although this disclosure describes and illustrates a touch sensor overlying a display, this disclosure contemplates other portions of a touch sensor (including other portions of conductive lines 280) being disposed on one or more layers on or within a display stack of the display. Furthermore, although this disclosure discusses conductive lines (e.g., conductive lines 280, as well as other conductive lines discussed in this disclosure) as “lines,” due to design intent or manufacturing variances, conductive lines may be straight, curved, jagged, randomized, vary according to a function (e.g., a sine wave function), or otherwise differ from a straight “line.” In an embodiment, conductive lines connect two points in space. In an embodiment, conductive lines connect two points in space, where each point is, or is relative to, a location on an alternating pixel display.

In an embodiment, conductive lines 280 are mono-chromatic conductive lines because they each cover (are positioned over and/or intersect), and thus, e.g., occlude, a portion of one or more sub-pixels of only one sub-pixel color. In the example of FIG. 2, conductive lines 280 cover portions of green sub-pixels 230, but not portions of red sub-pixels 210 or blue sub-pixels 220, and are therefore referred to as mono-chromatic conductive lines. In an embodiment, conductive lines 280 are vertical or horizontal conductive lines relative to the orientation of example portion 200 of an example alternating pixel display as shown in FIG. 2. Other mono-chromatic conductive lines may have different orientations and slopes, and may cover different sub-pixel colors. Other mono-chromatic conductive lines may cover a different sub-pixel color instead of green, and this disclosure contemplates different pixel and sub-pixel patterns, layouts, and sub-pixel colors.

FIG. 3 illustrates an example portion 200 of an example alternating pixel display that includes example pixels (e.g., 240a and 240b) and sub-pixels (e.g., 210, 220, 230), with example bi-chromatic conductive lines 310, 320, and 330 overlying the example portion 200 of an example alternating pixel display, according to an embodiment of the present disclosure. In an example embodiment, conductive lines 310, 320, and/or 330 form respective parts of a mesh pattern of an electrode of a touch sensor. Although this disclosure describes and illustrates a touch sensor overlying a display, this disclosure contemplates other portions of a touch sensor (including other portions of conductive lines 310, 320, and/or 330) being disposed on one or more layers on or within a display stack of the display.

In an embodiment, conductive lines 310, 320, and 330 are bi-chromatic conductive lines because they each cover (are positioned over and/or intersect), and thus, e.g., occlude, a portion of one or more sub-pixels of only two sub-pixel colors. In the example of FIG. 3, conductive line 310 covers portions of red sub-pixels 210 and blue sub-pixels 220, but not green sub-pixels 230. In an embodiment, conductive line 310 is a vertical conductive line relative to the orientation of example portion 200 of an example alternating pixel display as shown in FIG. 3. In the example of FIG. 3, conductive line 320 covers portions of red sub-pixels 210 and green sub-pixels 230, but not blue sub-pixels 220. In an embodiment, conductive line 320 is a conductive line with a slope of 1 vertical pixel pitch 270 over 1 horizontal pixel pitch 260, relative to the orientation of example portion 200 of an example alternating pixel display as shown in FIG. 3. In the example of FIG. 3, conductive line 330 covers portions of blue sub-pixels 220 and green sub-pixels 230, but not red sub-pixel 210. In an embodiment, conductive line 330 is a conductive line with a slope of 1 vertical pixel pitch 270 over 1 horizontal pixel pitch 260, relative to the orientation of example portion 200 of an example alternating pixel display as shown in FIG. 3. Other bi-chromatic conductive lines may have different orientations and slopes, and may cover different sub-pixel colors. This disclosure contemplates different pixel and sub-pixel patterns, layouts, and sub-pixel colors.

FIGS. 4A and 4B illustrate an example portion 200 of an example alternating pixel display that includes example pixels (e.g., 240a and 240b) and sub-pixels (e.g., 210, 220, 230), with example pseudo-chromatic conductive lines 410, 420, 430, 440, 450, and 460 overlying the example portion 200 of an example alternating pixel display, according to an embodiment of the present disclosure. In an example embodiment, conductive lines 410, 420, 430, 440, 450, and/or 460 form respective parts of a mesh pattern of an electrode of a touch sensor. Although this disclosure describes and illustrates a touch sensor overlying a display, this disclosure contemplates other portions of a touch sensor (including other portions of conductive lines 410, 420, 430, 440, 450, and/or 460) being disposed on one or more layers on or within a display stack of the display.

In an embodiment, conductive lines 410, 420, 430, 440, 450, and 460 are pseudo-chromatic conductive lines because they each cover (are positioned over and/or intersect), and thus, e.g., occlude, a portion of one or more sub-pixels of all three example sub-pixel colors. In an embodiment, whether a conductive line is a pseudo-chromatic conductive line depends on the size and orientation of particular sub-pixels, as well as the specific location of the conductive line. As an example, conductive lines 410 and 450 do not appear in FIGS. 4A and 4B to cover a portion of each pixel color (in the specific example shown in FIGS. 4A and 4B they appear to be bi-chromatic), but if conductive lines 410 and 450 are shifted (translated) to the left or right by certain distances, for instance, they are pseudo-chromatic. FIG. 6 shows how conductive lines like line 410 can be used pseudo-chromatically in a mesh. In the example of FIGS. 4A and 4B, conductive lines 420, 430, 440, and 460 each cover portions of red sub-pixels 210, blue sub-pixels 220, and green sub-pixels 230.

In an embodiment, conductive line 410 is a conductive line with a slope of 2 vertical pixel pitches 270 over 4 horizontal pixel pitches 260, relative to the orientation of example portion 200 of an example alternating pixel display as shown in FIGS. 4A and 4B. In an embodiment, conductive line 420 is a conductive line with a slope of 2 vertical pixel pitches 270 over 5 horizontal pixel pitches 260, relative to the orientation of example portion 200 of an example alternating pixel display as shown in FIGS. 4A and 4B. In an embodiment, conductive line 430 is a conductive line with a slope of 1 vertical pixel pitch 270 over 4 horizontal pixel pitches 260, relative to the orientation of example portion 200 of an example alternating pixel display as shown in FIGS. 4A and 4B. In an embodiment, conductive line 440 is a conductive line with a slope of 3 vertical pixel pitches 270 over 5 horizontal pixel pitches 260, relative to the orientation of example portion 200 of an example alternating pixel display as shown in FIGS. 4A and 4B. In an embodiment, conductive line 450 is a conductive line with a slope of 1 vertical pixel pitch 270 over 3 horizontal pixel pitches 260, relative to the orientation of example portion 200 of an example alternating pixel display as shown in FIGS. 4A and 4B. In an embodiment, conductive line 460 is a conductive line with a slope of 1 vertical pixel pitch 270 over 5 horizontal pixel pitches 260, relative to the orientation of example portion 200 of an example alternating pixel display as shown in FIGS. 4A and 4B.

In an embodiment, a portion of an example alternating pixel display has four sub-pixel colors (e.g., red, green, blue, and white), such that a pseudo-chromatic conductive line would cover a portion of all four example sub-pixel colors. In this embodiment where an alternating pixel display that has four sub-pixel colors, a trichromatic line would cover only three sub-pixel colors. Other pseudo-chromatic conductive lines may have different orientations and slopes, and may cover a different number of sub-pixels having different sub-pixel colors. This disclosure contemplates different pixel and sub-pixel patterns, layouts, and sub-pixel colors. However, it is noted that, in an embodiment, touch sensor meshes having at least some pseudo-chromatic conductive lines may reduce or eliminate certain moiré-pattern effects more effectively than touch sensor meshes having no pseudo-chromatic conductive lines.

FIG. 5 illustrates an example portion 200 of an example alternating pixel display that includes example pixels (e.g., 240a and 240b) and sub-pixels (210, 220, and 230), with an example set of parallel conductive lines 510 (similar to 410), 520, and 530 overlying the example portion 200 of an example alternating pixel display, according to an embodiment of the present disclosure. In particular, FIG. 5 illustrates different frequencies, measured in horizontal pixel pitches 260, at which parallel conductive lines are spaced. In an example embodiment, conductive lines 510, 520, and/or 530 form respective parts of a mesh pattern of an electrode of a touch sensor. Although this disclosure describes and illustrates a touch sensor overlying a display, this disclosure contemplates other portions of a touch sensor (including other portions of conductive lines 510, 520, and/or 530) being disposed on one or more layers on or within a display stack of the display. In an embodiment, for example in FIG. 5, the green sub-pixels 230 are offset from the red-sub-pixels 210 and blue sub-pixels 220 by 45 degrees.

In an embodiment, conductive lines 510, 520, and 530 can be pseudo-chromatic conductive lines because they can cover (are positioned over and/or intersect), and thus, e.g., occlude, a portion of one or more sub-pixels of all three example sub-pixel colors, even though in FIG. 5, the conductive lines appear bi-chromatic because they only cover red and blue sub-pixels (see discussion of conductive line 410 in connection with FIG. 4A, above). In the example of FIG. 5, conductive lines 510, 520, and 530 cover portions of red sub-pixels 210 and blue sub-pixels 220.

In an embodiment, conductive lines 510, 520, and 530 are conductive lines that are substantially parallel with each other, where each conductive line has a slope of 1 vertical pixel pitch 270 over 2 horizontal pixel pitches 260, relative to the orientation of example portion 200 of an example alternating pixel display as shown in FIG. 5. In an embodiment, the spacing between two adjacent parallel conductive lines is constant, and the spacing is repeated for additional parallel conductive lines. Thus, in an embodiment, parallel conductive lines are spaced at a particular separation frequency, which can be measured, for example, by a distance along a horizontal axis (e.g., along an axis parallel to a mono-chromatic line, horizontal axis 540, an axis horizontal to the display in FIG. 2, or horizontal axis 825 in FIG. 8). In an embodiment, a periodic set (or periodic series) of conductive lines contains, for example, a periodic series of parallel conductive lines that includes three or more conductive lines that are each substantially parallel to the others, wherein adjacent conductive lines from among these parallel conductive lines are separated from one another by the same (or substantially the same) separation distance. As such, the resulting pattern may include adjacent parallel lines, where the distance between adjacent parallel lines is determined, for example, based in part on a separation frequency (e.g., a particular separation distance). In the example shown in FIG. 5, conductive lines 510 and 520 are separated by a frequency 550 of 8 horizontal pixel pitches 260, measured along horizontal axis 540 (which is also parallel to a horizontal mono-chromatic line passing through green sub-pixels 230). Thus, the frequency 550 of parallel lines having the spacing of conductive lines 510 and 520 is even (it is 8 horizontal pixel pitches 260). Also in the example shown in FIG. 5, conductive lines 510 and 530 are separated by a frequency 560 of 7 horizontal pixel pitches 260, measured along horizontal axis 540. Thus, the frequency 560 of parallel lines having the spacing of conductive lines 510 and 530 is odd (it is 7 horizontal pixel pitches 260).

In the example of FIG. 5, conductive lines 510, 520, and 530 cover portions of red sub-pixels 210 and blue sub-pixels 220. The conductive lines appear as bi-chromatic, because they intersect the center of red 210 and blue 220 sub-pixels and have a separation frequency of an integer multiple of a pixel pitch (e.g., 7 or 8 horizontal pixel pitches 260). While conductive lines 510, 520, and 530 can cover green sub-pixels 230 and even be pseudo-chromatic if spaced apart differently (see discussion regarding FIG. 6), FIG. 5 shows how certain conductive lines, such as conductive lines 510, 520, and 530 at separation distances that are integer multiples of pixel pitches, may only cover some sub-pixel colors (for example, two colors out of three).

While an embodiment may have constant spacing between all or nearly all parallel lines (e.g., at the separation frequency), this disclosure contemplates other embodiments having non-constant spacing between parallel lines, for example by the use of phasor modulation techniques, intended or unintended manufacturing variances, various conductive line offset patterns, the use of multiple and/or alternating separation frequencies, and conductive lines that are curved, jagged, randomized, vary according to a function (e.g., a sine wave function), or otherwise differ from a straight “line.” This disclosure contemplates that conductive lines can be substantially parallel, even if the conductive lines are not straight lines. In an embodiment, non-constant spacing can be created by using a separation frequency and one or more of the non-constant spacing techniques described in this disclosure (e.g., those described in this paragraph), such that the resulting non-constant spacing between conductive lines can be based, at least in part, on the separation frequency (or a particular separation distance). In example embodiments, whether spacing between adjacent parallel conductive lines in a set of parallel conductive lines remains constant or non-constant, the set (or series) of parallel conductive lines can be described as a periodic set of parallel conductive lines. In one embodiment, however, a periodic set of parallel conductive lines has constant spacing, such that when parallel conductive lines are repeated at a certain frequency, for example, a periodic set of parallel conductive lines is formed.

FIG. 6 illustrates an example portion of an example alternating pixel display that includes example pixels (e.g., 240a and 240b) and sub-pixels (210, 220, and 230), with an example set of parallel conductive lines 510, 530, and 610 overlying the example portion 200 of an example alternating pixel display, according to an embodiment of the present disclosure. In an embodiment, the parallel lines of FIG. 6 are more effective at reducing certain moiré effects than the parallel lines of FIG. 5. In an example embodiment, conductive lines 510, 530, and 610 form respective parts of a mesh pattern of an electrode of a touch sensor. Although this disclosure describes and illustrates a touch sensor overlying a display, this disclosure contemplates other portions of a touch sensor (including other portions of conductive lines 510, 530, and 610) being disposed on one or more layers on or within a display stack of the display.

In particular, FIG. 6 illustrates the implementation of a separation frequency 620 that is equal to the separation frequency 560 (e.g., 7 horizontal pixel pitches 260), divided by 2. Thus, in the example shown in FIG. 6, the separation frequency 620 between adjacent parallel conductive lines 510 and 610, as well as between adjacent parallel conductive lines 610 and 530 is 3.5 horizontal pixel pitches 260. In an embodiment, conductive line 610 is parallel to (and thus has the same slope as) conductive lines 510 and 530. In an embodiment, the separation frequency between all or nearly all adjacent parallel conductive lines is constant (e.g., about 3.5 horizontal pixel pitches 260). In the example embodiment shown in FIG. 6, the separation frequency 620 is not an integer multiple of horizontal pixel pitch 260 (e.g., it is equal to an odd integer multiple of horizontal pixel pitch 260, specifically 7 divided by 2). As a result, in this example conductive lines 510 and 530 cover only red sub-pixels 210 and blue sub-pixels 220 (as discussing above in connection with FIG. 5), but conductive line 610, which is separated from conductive line 510 by 3.5 (7/2) horizontal pixel pitches, covers all three sub-pixel colors, primarily the green sub-pixels. Thus, in addition to conductive line 610 being pseudo-chromatic, conductive lines 510 and 610, collectively, cover a substantially equal amount of each sub-pixel color. By having two adjacent parallel conductive lines that, collectively, cover a substantially equal amount of each sub-pixel color (and have substantially equal color integration and therefore substantially equal intensity), certain moiré effects may be reduced. In certain embodiments, using separation frequencies that are not an integer multiple of horizontal pitch 260 (e.g., an odd integer multiple of horizontal pixel pitch 260 divided by 2, an integer multiple of horizontal pixel pitch 260 divided by 3, etc.) may reduce or eliminate certain moiré-pattern effects more effectively than using separation frequencies that are an integer multiple of horizontal pitch 260.

While an embodiment may have constant spacing between all or nearly all parallel lines, this disclosure contemplates other embodiments having non-constant spacing between parallel lines, for example by the use of phasor modulation techniques, intended or unintended manufacturing variances, various conductive line offset patterns, the use of multiple and/or alternating separation frequencies, and conductive lines that are curved, jagged, randomized, vary according to a function (e.g., a sine wave function), or otherwise differ from a straight “line.” This disclosure contemplates that conductive lines can be substantially parallel, even if the conductive lines are not straight lines.

In an embodiment, the separation frequency is cyclical chromatic, such that a conductive line (e.g., a pseudo-chromatic line) or a number of adjacent parallel conductive lines (which may or may not include one or more pseudo-conductive lines) occlude portions of each sub-pixel color of a display (e.g., example portion 200 of an example alternating pixel display). In an embodiment, this conductive line or this number of adjacent parallel conductive lines that occlude portions of each sub-pixel color of a display are repeated in a cyclical pattern, which can be part of a mesh of a touch sensor. In an embodiment, this conductive line or this number of adjacent parallel conductive lines that occlude portions of each sub-pixel color of a display occlude substantially equal portions of each sub-pixel color, and in an embodiment, are repeated in a cyclical pattern (e.g., a cyclical chromatic pattern). For example, conductive lines 510 and 610, collectively, occlude relatively equal portions of each sub-pixel color, and thus separation frequency 620 is cyclical chromatic. In an embodiment, a cyclical chromatic separation frequency produces a cyclical chromatic pattern when the substantially parallel conductive lines are repeated. In example embodiments, shorter integration periods (e.g., shorter distances before the cyclical pattern of conductive lines repeats itself) may more effectively reduce or eliminate certain moiré-pattern effects than longer integration periods. In the example of FIG. 6, the integration period is twice the separation frequency 620.

FIG. 7 illustrates an example portion 700 of a dual-layer mesh, where each example single-layer mesh (e.g., 710) includes two intersecting sets of parallel conductive lines (e.g., 711 and 712), according to an embodiment of the disclosure. In an embodiment, mesh 710 represents a single-layer mesh, and mesh 715 represents a single-layer mesh. In an embodiment, when superimposed on top of one another, these two single-layer meshes (710 and 715) become a dual-layer mesh (an example portion 700 of which is shown in FIG. 7).

In an embodiment, mesh 710 includes two sets of a plurality of parallel conductive lines, where the first set 711 intersects the second set 712, forming a mesh pattern, for example, a grid pattern having a number of cells (e.g., cell 760). In an embodiment, the conductive lines (711 and 712) that form mesh 710 are any of the conductive lines described in this disclosure. In this embodiment, the intersecting conductive lines (711 and 712) that form mesh 710 form a grid pattern having repeating cells, where each cell has various measurements, or dimensions.

In an embodiment, the cells of the mesh pattern are in the shape of quadrilaterals (which includes shapes that are substantially quadrilateral having, e.g., four vertices), though other shapes may be formed. For example, angle θ₁ 720 is an angle formed between a conductive line from the first set of parallel conductive lines 711 and a conductive line from the second set of parallel conductive lines 712. In an embodiment, angle θ₁ 720 is the angle at a first vertex of cell 760, which is a quadrilateral. In an embodiment, the angle at the vertex directly opposite of angle θ₁ 720 is the same as angle θ₁ 720. In an embodiment, angle θ₂ 725 is the angle at the second vertex of cell 760, where the second vertex is adjacent to the first vertex, not across from it. In an embodiment, the angle at the vertex directly opposite of angle θ₂ 725 is the same as angle θ₂ 725. In an embodiment, the sum of angle θ₁ 720 and angle θ₂ 725 is about 180 degrees. In an embodiment, angle θ₁ 720 is between 75 and 105 degrees, more specifically between 80 and 100 degrees, and more specifically between 85 and 95 degrees. In an embodiment, angle θ₁ 720 is about 90 degrees. In an embodiment, angle θ₂ 725 is between 75 and 105 degrees, more specifically between 80 and 100 degrees, and more specifically between 85 and 95 degrees. In an embodiment, angle θ₂ 725 is about 90 degrees. In an embodiment, both angle θ₁ 720 and angle θ₂ 725 are about 90 degrees (e.g., the first set of parallel conductive lines 711 and the second set of parallel conductive lines 712 are perpendicular to one another). In another embodiment, four angles are formed at the intersection of a conductive line from the first set of parallel conductive lines 711 and a conductive line from the second set of parallel conductive lines 712, where each of the four angles is between about 75 and 105 degrees, specifically between 80 degrees and about 100 degrees, and more specifically between 85 and 95 degrees. In an embodiment, all four angles are about 90 degrees. In an embodiment, angle θ₁ 720 and angle θ₂ 725 can represent two of the four angles, and in another embodiment, angle θ₁ 720 can represent two of the four angles opposite from one another, and angle θ₂ 725 can represent the other two of the four angles opposite from one another.

While embodiments of this disclosure describe quadrilateral shapes, which can include substantially quadrilateral shapes, in an example embodiment, a substantially quadrilateral shape is not a perfect quadrilateral, and is formed by one or more conductive lines that are not perfectly straight lines. In this example embodiment, the one or more conductive lines of the substantially quadrilateral shape may be curved, jagged, randomized, vary according to a function (e.g., a sine wave function), or otherwise differ from a straight “line.” Likewise, because one or more conductive lines may not be straight, the sum of four angles of the substantially quadrilateral shape may be more or less than 360 degrees, and/or the sum of, for example, the sum of angle θ₁ 720 and angle θ₂ 725 may be more or less than 180 degrees. In an embodiment, quadrilaterals formed by conductive lines having angles (or slopes) that result in equidistant vertices may be more effective in reducing certain moiré-pattern effects, e.g., low-frequency moiré-pattern effects.

In an embodiment, a cell of mesh 710 includes a first cell length 730 and a second cell length 735. In an embodiment, the first cell length 730 is the length of a conductive line from the first set of parallel conductive lines 711 between two adjacent conductive lines from the second set of parallel conductive lines 712. In an embodiment, the second cell length 735 is the length of a conductive line from the second set of parallel conductive lines 712 between two adjacent conductive lines from the first set of parallel conductive lines 711. In an embodiment, first cell length 730 and/or second cell length 735 are between 0.2 mm and 1 mm long, more specifically between 0.3 mm and 0.6 mm long, and more specifically between 0.4 mm and 0.5 mm long. In an embodiment, first cell length 730 and second cell length 735 are about the same. 1 mm equals 1000 μm (micrometers).

In an embodiment, the ratio of first cell length 730 to second cell length 735 (or vice versa) can be described as an aspect ratio of a cell (e.g., cell 760) in the mesh 710. As an example, an aspect ratio can be particularly applicable to the situation where cell 760 is substantially a quadrilateral. In an embodiment the ratio of first cell length 730 to second cell length 735 is between 2:1 and 0.5:1, specifically between 1.5:1 and 0.66:1, and more specifically between 1.2:1 and 0.83. In an embodiment, the ratio of first cell length 730 to second cell length 735 is about 1:1. In an embodiment, the ratio of first cell length 730 to second cell length 735 is about 1:1 (e.g., they have the same length), and first cell length 730 and second cell length 735 are between 0.4 mm and 0.5 mm long, specifically 0.42 mm long.

In an embodiment, a cell of mesh 710 includes a first diagonal length 740 and a second diagonal length 745, where, for example, first diagonal length 740 is the distance between two opposite vertices of a cell in mesh 710 (e.g., those having angle θ₁ 720), and second diagonal length 745 is the distance between another set of two opposite vertices of a cell in mesh 710 (e.g., those having angle θ₂ 725). In an embodiment, first diagonal length 740 and second diagonal length 745 are the same when the aspect ratio of the first cell length 730 and the second cell length 735 is 1:1. In an embodiment, first diagonal length 740 and/or second diagonal length 745 are between 2.2 mm and 0.28 mm long, specifically between 1 mm and 0.4 mm long, and more specifically between 0.7 mm and 0.5 mm long. In an embodiment, first diagonal length 740 and/or second diagonal length 745 are between about 0.68 mm and 0.52 mm long, and specifically about 0.6 mm long. In an embodiment, the furthest distance between any two vertices in a substantially quadrilateral cell (e.g., cell 760) is between about 400 and 800 micrometers, specifically between about 520 micrometers and about 680 micrometers, and more specifically between about 560 micrometers and about 640 micrometers.

In an embodiment, mesh 715 is similar to mesh 710, and has the same types of measurements as mesh 715, though the specific value of any particular measurement or dimension can differ. In an embodiment, mesh 715 is offset from mesh 710 and superimposed on, under, or interwoven with mesh 710 to form a dual-layer mesh (e.g., portion 700 of an example dual layer mesh). In an embodiment, some or all of the measurements or dimensions of mesh 715 are the same as mesh 710. In an embodiment, meshes 710 and 715 are layered such that mesh 715 is offset from mesh 710 such that the vertices of mesh 715 are located in the center (or, e.g., within an about 50 micrometer or less radius from the center) of the grid cells of mesh 710 and the vertices of mesh 710 are located in the center (or, e.g., within an about 50 micrometer or less radius from the center) of the grid cells of mesh 715. In an embodiment, a first mesh (e.g., 710) and a second mesh (e.g., 715) are layered such that a plurality of the vertices of a first at least one substantially quadrilateral shape (e.g., cell 760) are located within an about less than 100 micrometer (e.g., within a 30 micrometer) radius of the center of a second at least one substantially quadrilateral shape (e.g., a cell formed by mesh 715), and/or the first and second meshes are layered such that a plurality of the vertices of the second at least one substantially quadrilateral shape are located within an about less than 100 micrometer (e.g., within a 30 micrometer) radius of the center of the first at least one substantially quadrilateral shape. This disclosure also contemplates the design and use of different numbers of meshes, any one of which (or any number of which) can be designed or used in any way that is consistent with this disclosure, and which may be used independently or in conjunction with each other or with any number of other meshes (e.g., layered together as single or multiple conductive elements of a touch sensor).

In an embodiment, both mesh 710 and 715 have the about same measurements or dimensions, angle θ₁ 720 and angle θ₂ 725 are each about 90 degrees, the aspect ratio of first cell length 730 and second cell length 735 is about 1:1, first cell length 730 and second cell length 735 are about 0.42 mm long, and first diagonal length 740 and second diagonal length 745 are about 0.6 mm long.

In an embodiment, once the dual-layer mesh is formed, each cell (e.g., cell 760) of mesh 710 is divided into multiple sub-cells, for example four sub-cells (e.g., sub-cell 765). In an embodiment, a sub-cell (e.g., sub-cell 765) includes a first sub-cell diagonal length 750 and a second sub-cell diagonal length 755, where, for example, first sub-cell diagonal length 750 is the distance between two opposite vertices of a sub-cell in the dual-layer mesh (e.g. dual-layer mesh portion 700), and second sub-cell diagonal length 755 is the distance between another set of two opposite vertices of a sub-cell in the dual-layer mesh ((e.g. dual-layer mesh portion 700)). In an embodiment, first sub-cell diagonal length 750 and/or second sub-cell diagonal length 755 are between 1.1 mm and 0.14 mm long, specifically between 0.5 mm and 0.2 mm long, and more specifically between 0.35 mm and 0.25 mm long. In an embodiment, first sub-cell diagonal length 750 and/or second sub-cell diagonal length 755 are between about 0.34 mm and 0.26 mm long, and specifically about 0.3 mm long.

In an embodiment, some or all of the conductive lines of a mesh (e.g., mesh 710 and/or 715) may be mono-chromatic, bi-chromatic, tri-chromatic, etc., or pseudo-chromatic. In example embodiments, meshes having more pseudo-chromatic conductive lines (or in general having conductive lines that, collectively, occlude each sub-pixel color of a display, e.g., substantially equally) may produce reduced moiré-pattern effects compared to meshes having fewer pseudo-chromatic conductive lines (or in general having conductive lines that, collectively, do not occlude each sub-pixel color of a display, e.g., substantially equally). In an embodiment, a mesh acts as a conductive layer of a touch screen on an alternating pixel display and includes two sets of intersecting conductive lines. Specifically, in an embodiment, the mesh (e.g., single-layer mesh 710) includes a first periodic series of multiple substantially parallel conductive lines (e.g., conductive lines 711), where adjacent conductive lines are separated by a first distance (e.g., second cell length 735), that intersects with a second periodic series of multiple substantially parallel conductive lines (e.g., conductive lines 712), where adjacent conductive lines are separated by a second distance (e.g., first cell length 730). Additionally, in an embodiment, a first conductive line and an adjacent second conductive line (of the first or second periodic series of multiple conductive lines) include (1) at least one pseudo-chromatic conductive line that covers at least a portion of each sub-pixel color of the display or (2) an at least bi-chromatic conductive line that covers at least a portion of two sub-pixel colors, and another conductive line that, collectively with the at least bi-chromatic conductive line, occlude at least a portion of each sub-pixel color.

In an embodiment, a single-layer or dual-layer mesh covers between about 1% and about 7% of the total area of the sub-pixels on a display, specifically between about 3% and about 5% of the total area of the sub-pixels on a display, and more specifically about 4% of the total area of the sub-pixels on a display. The area covered by conductive lines may be known as the film density or mesh density. In an embodiment, conductive lines used in a single or dual-layer mesh, including a conductive element of a touch sensor, are between about 1 micron and 7 microns wide, specifically about 3 microns and about 5 microns wide, and more specifically about 4 microns wide.

In an embodiment, a single-layer mesh (e.g., mesh 710), as opposed to a dual-layer mesh, is used in a touch sensor. In a single-layer mesh embodiment, first diagonal length 740 and/or second diagonal length 745 are between 1.1 mm and 0.14 mm long, specifically between 0.5 mm and 0.2 mm long, and more specifically between 0.35 mm and 0.25 mm long. In single-layer mesh embodiment, first diagonal length 740 and/or second diagonal length 745 are between about 0.34 mm and 0.26 mm long, and specifically about 0.3 mm long. In single-layer mesh embodiment, the furthest distance between any two vertices in a substantially quadrilateral cell (e.g., cell 760) is between about 200 and 400 micrometers, specifically between about 260 micrometers and about 340 micrometers, and more specifically between about 280 micrometers and about 320 micrometers.

While this disclosure describes example mesh embodiments having specific measurements and dimensions, aspect ratios, angles, cell shapes, patterns, and single-layer or dual-layer meshes, this disclosure contemplates other embodiments having other measurements and dimensions, aspect ratios, angles, cell shapes, patterns, and numbers of mesh layers.

FIG. 8 illustrates an example portion 800 of an example alternating pixel display that includes example pixels and sub-pixels (801, 802, 803), with a first example set of parallel conductive lines (including 810 and 815) intersecting with a second example set of parallel conductive lines (including 835 and 840) to form a mesh overlying the example portion 800 of an example alternating pixel display, according to an embodiment of the present disclosure. In particular, FIG. 8 illustrates a particular mesh having particular measurements and dimensions. In an example embodiment, conductive lines 810, 815, 835, and 845 form respective parts of a mesh pattern of an electrode of a touch sensor. Although this disclosure describes and illustrates a touch sensor overlying a display, this disclosure contemplates other portions of a touch sensor (including other portions of conductive lines 810, 815, 835, and 845) being disposed on one or more layers on or within a display stack of the display.

In the example embodiment of FIG. 8, the example portion of example alternating pixel display 800 includes various sub-pixels, for example red sub-pixels 801, blue sub-pixels 802, and green sub-pixels 803. These sub-pixels are in certain embodiments, similar to red sub-pixel 210, blue sub-pixel 220, and green sub-pixel 230. In the example of FIG. 8, the sub-pixels have different orientations and/or shapes than the sub-pixels in FIG. 2. This disclosure contemplates other sub-pixels having different colors, shapes, and orientations.

In the example embodiment of FIG. 8, the example portion of example alternating pixel display 800 includes pixels 804a and 804b, where pixels 804a contain a red sub-pixel 801 and a green sub-pixel 803, and where pixels 804b contain a blue sub-pixel 802 an a green sub-pixel 803. While certain sub-pixels are shown within certain pixels in the example embodiments, other combinations of sub-pixels and sub-pixel colors in different pixels are contemplated. In the example of FIG. 8, pixels 804a and 804b have a horizontal sub-pixel pitch 805 and a vertical sub-pixel pitch 806. In this embodiment that includes an alternating pixel display, the horizontal sub-pixel pitch 805 and vertical sub-pixel pitch 806 are the same as the horizontal pixel pitch and vertical pixel pitch, respectively. In an embodiment, the horizontal and vertical sub-pixel pitches for each pixel type (804a and 804b) are the same length, and in other embodiments they are different lengths.

In the example embodiment of FIG. 8, the first example set of parallel conductive lines include conductive lines 810 and 815. Conductive line 810 is, in this example, representative of the other conductive lines of this first example set, except, for example, its exact position over display portion 800 and its relative position to the other conductive lines to which conductive line 810 is parallel. Conductive line 810 is a pseudo-chromatic line in this example. In an embodiment, the separation distance 820 (or the separation frequency) between adjacent conductive lines in the first set of parallel conductive lines, e.g. the separation distance 820 between conductive lines 810 and 815, is 29 horizontal sub-pixel pitches 805 divided by 2. In an embodiment, separation distance 820 (also known as the separation frequency) is cyclically chromatic and/or causes a set of adjacent parallel conductive lines to be cyclically chromatic. In an embodiment, relative to horizontal axis 825, conductive line 810 has a positive slope of 1 vertical sub-pixel pitch 806 and 4 horizontal sub-pixel pitches 805, and thus has an angle 830 relative to horizontal axis 825 of arctan(1/4)=about 14 degrees.

In the example embodiment of FIG. 8, the second example set of parallel conductive lines include conductive lines 835 and 840. Conductive line 835 is, in this example, representative of the other conductive lines of this second example set, except, for example, its exact position over display portion 800 and its relative position to the other conductive lines to which conductive line 835 is parallel. Conductive line 835 is a pseudo-chromatic line in this example. In an embodiment, the separation distance 845 (or the separation frequency) between adjacent conductive lines in the second set of parallel conductive lines, e.g. the separation distance 845 between conductive lines 835 and 840, is 25 horizontal sub-pixel pitches 805 divided by 8. In an embodiment, separation distance 845 (also known as the separation frequency) is cyclically chromatic and/or causes a set of adjacent parallel conductive lines to be cyclically chromatic. In an embodiment, relative to horizontal axis 825, conductive line 835 has a negative slope of 4 vertical sub-pixel pitches 806 and 1 horizontal sub-pixel pitch 805, and thus has an angle 850 relative to horizontal axis 825 of arctan(−4/1)=about −76 degrees. In this embodiment, the absolute value of angle 830 plus the absolute value of angle 850 equals about 90 degrees, and thus, for example, the first and second example sets of parallel conductive lines in this example are about orthogonal (about 90 degrees) to each another. In another embodiment, the absolute value of angle 830 plus the absolute value of angle 850 equals about 90 degrees (+/−about 15 degrees).

In an embodiment, the separation distance (separation frequency) between one or more sets of adjacent conductive lines (e.g., separation distance 820 and/or 845) that form one or more meshes is calculated to be about an odd integer multiple of a pixel pitch (e.g., a horizontal pixel pitch) of an alternating pixel display (e.g., 800), divided by an integer greater than or equal to 2. Alternatively, this separation distance can be expressed as: (pixel pitch)×[(odd integer)/(integer >=2)].

In an embodiment, a mesh is formed, for example, by the intersecting first and second example sets of parallel conductive lines, where the mesh is part of a conductive element of a touch sensor. In an embodiment, the intersecting first and second example sets of parallel conductive lines forms a mesh with cells that are substantially quadrilateral. In an embodiment, some or all of the conductive lines of the first and/or second set of parallel conductive lines are pseudo-chromatic when overlaid on an alternating pixel display. In an embodiment, conductive lines of a mesh overlay the center of some sub-pixels, and for example, may overlay the center of some sub-pixels in a repeating pattern. In another embodiment, conductive lines of a mesh do not overlay the center of some (or any) sub-pixels, and, for example, a mesh can be translated in any direction across a display regardless of whether certain conductive lines overlay the center of certain (or any) pixels. In an embodiment, when substantially all the conductive lines of a mesh are pseudo-chromatic and have separation distances equal to (pixel pitch)×[(odd integer)/(integer >=2), then moving the mesh orthogonally relative to the pixels (translation) has minimal, if any, adverse effect on color integration. In an embodiment, when substantially all the conductive lines of a mesh are bi-chromatic or tri-chromatic and have separation distances equal to (pixel pitch)×[(odd integer)/(integer >=2), then moving the mesh orthogonally relative to the pixels (translation) has minimal, if any, adverse effect on color integration.

In an embodiment, angles of conductive lines (e.g. angle 830, angle 850, angle θ₁ 720, and/or angle θ₂ 725) may vary due to, for example, misalignment during manufacturing. Similarly, the placement of a mesh over a display may vary due to, for example, rotation of the mesh during manufacturing. In an embodiment, a mesh can tolerate a misalignment, e.g., a rotation of the mesh, of a number of degrees, for example about +/−0.5 degrees relative to the pixels of a display. While FIG. 8 describes an example embodiment with a display and sets of example conductive lines having certain measurements, angles, orientations, patterns, and layouts, this disclosure comprehends different measurements, angles, orientations, patterns, and layouts.

In addition, although this disclosure discusses conductive lines (e.g., conductive lines 810 and 815, as well as other conductive lines discussed in this disclosure) as “lines,” due to design intent or manufacturing variances, conductive lines may be straight, curved, jagged, randomized, vary according to a function (e.g., a sine wave function), or otherwise differ from a straight “line.” In an embodiment, conductive lines connect two points in space. Furthermore, while embodiments of this disclosure describe quadrilaterals or quadrilateral shapes, which can include substantially quadrilateral shapes, in an example embodiment, a substantially quadrilateral shape is not a perfect quadrilateral, and is formed by one or more conductive lines that are not perfectly straight lines. In this example embodiment, the one or more conductive lines of the substantially quadrilateral shape may be curved, jagged, randomized, vary according to a function (e.g., a sine wave function), or otherwise differ from a straight “line.” Likewise, because one or more conductive lines may not be straight, the sum of four angles of the substantially quadrilateral shape may be more or less than 360 degrees, and/or the sum of, for example, the sum of angle θ₁ 720 and angle θ₂ 725 may be more or less than 180 degrees. Additionally, although the example in FIG. 8 shows two example sets of parallel conductive lines having certain slopes, angles, and separation distances, other sets of parallel conductive lines are contemplated, for example those shown in TABLE 1.

TABLE 1
Example Measurements of Example Sets of Parallel
Conductive Lines, which Form Example Meshes

| | | | | Separation Distance/ |
|---|---|---|---|---|
| | Parallel | | | Separation Frequency |
| Mesh | Line | | | (units = horiz. |
| Example | Set | Slope | Angle | pixel pitch) |
| 1 | Set 1 | +1/4 | arctan (1/4) = 14° | 14 |
| | Set 2 | −4/1 | arctan (−4/1) = −76° | 3 |
| 2 | Set 1 | +1/4 | arctan (1/4) = 14° | 29/2 |
| | Set 2 | −4/1 | arctan (−4/1) = −76° | 25/8 |
| 3 | Set 1 | +1/4 | arctan (1/4) = 14° | 15 |
| | Set 2 | −4/1 | arctan (−4/1) = −76° | 3 |
| 4 | Set 1 | +1/4 | arctan (1/4) = 14° | 31/2 |
| | Set 2 | −4/1 | arctan (−4/1) = −76° | 25/8 |
| 5 | Set 1 | +2/3 | arctan (2/3) = 34° | 21/4 |
| | Set 2 | −3/2 | arctan (−3/2) = −56° | 25/6 |
| 6 | Set 1 | +2/3 | arctan (2/3) = 34° | 25/4 |
| | Set 2 | −3/2 | arctan (−3/2) = −56° | 25/6 |
| 7 | Set 1 | +2/3 | arctan (2/3) = 34° | 25/4 |
| | Set 2 | −2/1 | arctan (−2/1) = −63° | 17/4 |
| 8 | Set 1 | +1/2 | arctan (1/2) = 27° | 19/2 |
| | Set 2 | −2/1 | arctan (−2/1) = −63° | 17/4 |

Table 1 provides example measurements. Different displays can have different characteristics, for example, different displays come in different resolutions (e.g., pixel pitches). Therefore, in an embodiment, sets of substantially parallel conductive lines that form example meshes have one or more combination of angle and separation distance/frequency measurements that (1) cover a substantially equal amount of each sub-pixel color (e.g., provide substantially equal color integration) and (2) produce mesh densities of about 4% (e.g., conductive lines having a width of about 4 micrometers form quadrilateral mesh cells that, in a dual-layer embodiment, have an about 260 to 340 micrometer sub-cell diagonal length (e.g., 750 and/or 755) and in a single-layer embodiment, have an about 260 to 340 micrometer diagonal length (e.g., 740 and/or 745)).

FIG. 9 illustrates an example method 900 for forming one or more electrodes of a touch sensor, according to an embodiment of the present disclosure. The method starts at step 910 where a mesh of conductive material is deposited on a substrate. This disclosure contemplates any technique for depositing a mesh of conductive material on a substrate, such as for example, printing of a mesh onto a substrate, evaporation, sputtering, physical vapor deposition, chemical vapor deposition, or photolithography. In an embodiment, the mesh (e.g., mesh 710 and/or mesh 715, or the mesh shown in FIG. 8) of conductive material is configured to extend across a display that includes multiple pixels 240 (e.g., multiple pixels 240a and 240b or 804a and 804b). In an embodiment, the mesh (e.g., mesh 710, or the mesh shown in FIG. 8) includes first lines of conductive material that are substantially parallel to each other and second lines of conductive material that are substantially parallel to each other. In an embodiment, the first and second lines are configured to extend across the display at first and second angles (e.g., angles 830 and 850) and first and second slopes that are determined in any manner. In an embodiment, the first and second lines each have respective separation distances (e.g., 820 and 845) and cell lengths (e.g., 730 and 735) that are determined in any manner, and that, for example, are determined to be within the ranges described above.

At step 920, one or more electrodes of a touch sensor are formed from the mesh of conductive material, at which point the method ends. This disclosure contemplates any technique for forming electrodes from a mesh of conductive material, such as for example, by etching, cutting, or ablating to remove one or more portions of the mesh of conductive material. Although this disclosure describes and illustrates particular steps of the method of FIG. 9 as occurring in a particular order, this disclosure contemplates any steps of the method of FIG. 9 occurring in any order. An embodiment can repeat or omit one or more steps of the method of FIG. 9. Moreover, although this disclosure describes and illustrates an example method for forming electrodes of a touch sensor including the particular steps of the method of FIG. 9, this disclosure contemplates any method for forming electrodes of a touch sensor including any steps, which can include all, some, or none of the steps of the method of FIG. 10. Moreover, although this disclosure describes and illustrates particular components carrying out particular steps of the method of FIG. 9, this disclosure contemplates any combination of any components carrying out any steps of the method of FIG. 9.

FIG. 10 illustrates an example method 1000 for forming one or more touch sensors having one or more meshes, according to an embodiment of the present disclosure. The method starts at step 1010, which includes designing a mesh of conductive material, specifically via steps 1020-1060, and then continues to step 1070, where the mesh, once designed, is formed on a substrate. The method ends at step 1080, where a touch sensor is formed that includes the mesh.

At step 1020, first substantially parallel conductive lines of the mesh are configured to have adjacent conductive lines separated by a first distance. In an embodiment, the mesh of conductive material is designed as having first lines of conductive material that are substantially parallel to each other (e.g., conductive lines 810 and 815) and that have a first separation distance between the first lines. In an embodiment, the first lines that are adjacent to each other are separated from each other along the first axis (e.g., horizontal axis 825) by a first separation distance (e.g., separation distance 820) that is determined in any manner, such as by any of the above-described manners. In an embodiment, the first substantially parallel conductive lines extend across a display at a first angle (e.g., angle 830) relative to an axis (e.g., horizontal axis 825). In an embodiment, the first lines are configured to extend across an alternating pixel display (e.g., display portion 200 or 800) at first angle (e.g., angle 830), where the first angle is determined in any manner.

At step 1030, the first substantially parallel conductive lines are configured to include a first conductive line and an adjacent second conductive line. In an example embodiment, the first conductive line is conductive line 810 and the second conductive line is conductive line 815, which are adjacent to each other.

At step 1040, the first conductive line and the adjacent (second) conductive line are configured to include an at least bi-chromatic conductive line and another conductive line that, collectively, cover (and thus, e.g., occlude) at least a portion of each sub-pixel color in an alternating pixel display. In an embodiment, the first conductive line and the adjacent conductive line are configured to include (1) an at least bi-chromatic conductive line adapted to cover at least a portion of two sub-pixel colors of a plurality of sub-pixel colors of a plurality of sub-pixels of an alternating pixel display, the plurality of sub-pixels being arranged according to an alternating pixel display pattern, each sub-pixel corresponding to a particular sub-pixel color of the plurality of sub-pixel colors, and (2) another conductive line that, collectively with the at least bi-chromatic conductive line, are adapted to cover at least a portion of each sub-pixel color of the plurality of sub-pixel colors of the plurality of sub-pixels of the alternating pixel display. In an embodiment, the first conductive line and the adjacent conductive line, collectively, cover (and occlude) a substantially equal amount of each sub-pixel color. In an example embodiment, the first conductive line is conductive line 810 and the adjacent (second) conductive line is conductive line 815, and both are pseudo-chromatic. In an embodiment, both pseudo chromatic lines, collectively, cover substantially equal amounts (e.g., within 33% of each other or less) of each sub-pixel color, such that the first and second conductive lines are cyclically chromatic and, for example, have an integration period that is equal to about two times the separation distance between the first and second conductive lines. If the first and second conductive lines are cyclically repeated, they may reduce or eliminate certain moiré effects. In an embodiment, the first conductive line is pseudo-chromatic and cyclically chromatic on its own (and, e.g., covers a substantially equal amount of each sub-pixel color). Thus, if the first line in this example is repeated, the resulting set of parallel lines would have an integration period of about one separation distance.

In another example, an alternating pixel display (having an alternating pixel display pattern) has three sub-pixel colors (red, green and blue), and the first conductive line is bi-chromatic (covering red and green), and the second conductive line is either mono-chromatic or bi-chromatic, such that it covers blue. In an embodiment, the first conductive line and the second conductive line, collectively, cover all three sub-pixel colors. In an embodiment, the first conductive line and the second conductive line cover substantially equal amounts (e.g., within 33% of each other or less) of each sub-pixel color, such that the first and second conductive lines are cyclically chromatic and, for example, have an integration period that is equal to about two times the separation distance between the first and second conductive lines. If the first and second conductive lines are cyclically repeated, they may reduce or eliminate certain moiré effects. In other embodiments, a set of cyclically chromatic conductive lines may include three, four, or more conductive lines before each sub-pixel color is covered in substantially equal amounts. In such embodiments, the integration period may increase to about three, four, or more times the separation distance, respectively. While example embodiments using three sub-pixel colors are described, alternating pixel displays having a different number of sub-pixel colors are also contemplated. For example, for a display having four sub-pixel colors, the first conductive line may be a tri-chromatic line covering white, green, and blue sub-pixels, and the second conductive line may be a mono-chromatic, bi-chromatic, or tri-chromatic line covering red sub-pixels.

In an embodiment, the first and adjacent second conductive lines are part of at least 5 adjacent conductive lines, where adjacent conductive lines of the at least 5 adjacent conductive lines are separated by a separation distance of about an odd integer multiple of a pixel pitch of an alternating pixel display, divided by an integer greater than or equal to 2. Alternatively, the separation distance in this embodiment can be expressed as: (pixel pitch)×[(odd integer)/(integer >=2)]. In an embodiment, at least 50% of the at least 5 adjacent conductive lines are pseudo-chromatic conductive lines adapted to cover at least a portion of each sub-pixel color of the alternating pixel display, and the pseudo-chromatic conductive lines, collectively, cover substantially equal amounts (within about 33% of each other or less) of each sub-pixel color.

At step 1050, second substantially parallel conductive lines of the mesh are configured to have adjacent conductive lines separated by a second distance. In an embodiment, the mesh of conductive material is designed as having second lines of conductive material that are substantially parallel to each other (e.g., conductive lines 835 and 840) and have a second separation distance between the second lines. In an embodiment, the second lines that are adjacent to each other are separated from each other along the first axis (e.g., horizontal axis 825) by a second separation distance (e.g., separation distance 845) that is determined in any manner, such as by any of the above-described manners. In an embodiment, the second substantially parallel conductive lines extend across a display at a second angle (e.g., angle 850) relative to an axis (e.g., horizontal axis 825). In an embodiment, the second lines are configured to extend across an alternating pixel display (e.g., display portion 200 or 800) at second angle (e.g., angle 850), where the second angle is determined in any manner.

At step 1060, the first substantially parallel conductive lines are configured to intersect with the second substantially parallel conductive lines to form a mesh pattern. In an example embodiment, the first and second substantially parallel conductive lines intersect when, relative to an axis (e.g., horizontal axis 825), the angle of the first conductive lines (e.g., angle 830) is not equal to the angle of the second conductive lines (e.g., angle 850).

At step 1070, the mesh of conductive material is formed on a substrate. This disclosure contemplates any technique for forming the mesh, which can be formed on any substrate. In an embodiment, the mesh is configured to extend across an alternating pixel display (e.g., display portion 200 or 800). In an embodiment, the mesh is designed according to some or all of the previous steps of the method of FIG. 10. In an embodiment, additional techniques are used to modify the conductive lines and/or line spacing. For example, using phasor modulation techniques, randomizing the spacing of some or all of the first lines and/or the second lines, slightly modifying the shape of some or all of the first lines and or second lines (e.g., slightly curving some or all of the lines according to a sinusoidal function or any other function), or any other techniques (e.g., those described in this disclosure) may be used.

At step 1080, a touch sensor is formed that includes the mesh. This disclosure contemplates any technique for forming the touch sensor. In an embodiment, the touch sensor is configured to extend across an alternating pixel display (e.g., display portion 200 or 800). In an embodiment, the touch sensor includes a mesh that is designed according to some or all of the previous steps of the method of FIG. 10.

Although this disclosure describes and illustrates particular steps of the method of FIG. 10 as occurring in a particular order, this disclosure contemplates any steps of the method of FIG. 10 occurring in any order. An embodiment can repeat or omit one or more steps of the method of FIG. 10. In an embodiment, some or all of the steps of the method of FIG. 9 can include or replace some or all of the steps of the method of FIG. 10. In an embodiment, some or all of the steps of the method of FIG. 10 can include or replace some or all of the steps of the method of FIG. 9. Moreover, although this disclosure describes and illustrates particular components carrying out particular steps of the method of FIG. 10, this disclosure contemplates any combination of any components carrying out any steps of the method of FIG. 10.

FIG. 11 illustrates an example computer system (e.g., device 1100), according to an embodiment of the present disclosure. In an embodiment, device 1100 is any personal digital assistant, cellular telephone, smartphone, tablet computer, and the like. In one embodiment, device 1100 includes other types of devices, such as automatic teller machines (ATMs), home appliances, personal computers, and any other such device having a touch screen. In the illustrated example, components of touch sensor 100 are internal to device 1100. Although this disclosure describes a particular device 1100 having a particular implementation with particular components, this disclosure contemplates any device 1100 having any implementation with any components.

A particular example of device 1100 is a smartphone that includes a housing 1101 and a touch screen display 1102 occupying a portion of a surface 1104 of housing 1101 of device 1100. In an embodiment, housing 1101 is an enclosure of device 1100, which contains internal components (e.g., internal electrical components) of device 1100. In an embodiment, touch sensor 100 is coupled, directly or indirectly, to housing 1101 of device 1100. In an embodiment, touch screen display 1102 occupies a portion or all of a surface 1104 (e.g., one of the largest surfaces 1104) of housing 1101 of device 1100. Reference to a touch screen display 1102 includes cover layers that overlay the actual display and touch sensor elements of device 1100, including a top cover layer (e.g., a glass cover layer). In the illustrated example, surface 1104 is a surface of the top cover layer of touch screen display 1102. In an embodiment, the top cover layer (e.g., a glass cover layer) of touch screen display 1100 is considered part of housing 1101 of device 1100.

In one embodiment, the size of touch screen display 1102 allows the touch screen display 1102 to present a wide variety of data, including a keyboard, a numeric keypad, program or application icons, and various other interfaces. In one embodiment, a user interacts with device 1100 by touching touch screen display 1102 with a stylus, a finger, or any other object in order to interact with device 1100 (e.g., select a program for execution or to type a letter on a keyboard displayed on the touch screen display 1102). In one embodiment, a user interacts with device 1100 using multiple touches to perform various operations, such as to zoom in or zoom out when viewing a document or image. In some embodiments, such as home appliances, touch screen display 1102 recognizes only single touches.

In an embodiment, users interact with device 1100 by physically impacting surface 1104 (or another surface) of housing 1101 of device 1100, shown as impact 1106, or coming within a detection distance of touch sensor 100 using an object 1108, such as, for example, one or more fingers, one or more styluses, or other objects. In one embodiment, surface 1104 is a cover layer that overlies touch sensor array 12 and a display of device 1100.

Device 1100 includes buttons 1110, which when pressed, in an example embodiment, cause a processor to perform any function in relation to the operation of device 1100. As an example, one or more of buttons 1110 (e.g., button 1110b) may operate as a so-called “home button” that, at least in part, indicates to device 1100 that a user is preparing to provide input to touch sensor 100 of device 1100.

Herein, reference to a computer-readable non-transitory storage medium or media can include one or more semiconductor-based or other integrated circuits (ICs) (such, as for example, a field-programmable gate array (FPGA) or an application-specific IC (ASIC)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards, SECURE DIGITAL drives, any other computer-readable non-transitory storage medium or media, or any combination of two or more of these. A computer-readable non-transitory storage medium or media can be volatile, non-volatile, or a combination of volatile and non-volatile.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An apparatus comprising:
a substrate; and
a first conductive layer of a touch sensor coupled to the substrate, the first conductive layer comprising a first mesh of conductive lines, the first mesh comprising:
a first periodic series of conductive lines comprising a first plurality of conductive lines; and
a second periodic series of conductive lines comprising a second plurality of conductive lines;
the first plurality of conductive lines intersecting at least two of the second plurality of conductive lines; and
a first conductive line and an adjacent second conductive line of the first plurality of conductive lines comprising:
an at least bi-chromatic conductive line adapted to cover at least a portion of two sub-pixel colors of a plurality of sub-pixel colors of a plurality of sub-pixels of an alternating pixel display, the plurality of sub-pixels being arranged according to an alternating pixel display pattern, each sub-pixel corresponding to a particular sub-pixel color of the plurality of sub-pixel colors; and
another conductive line that, collectively with the at least bi-chromatic conductive line, are adapted to cover at least a portion of each sub-pixel color of the plurality of sub-pixel colors of the plurality of sub-pixels of the alternating pixel display.

2. The apparatus of claim 1, wherein the plurality of sub-pixel colors comprises red, blue, and green.

3. The apparatus of claim 1, wherein:
the first plurality of conductive lines comprise at least 5 adjacent conductive lines;
adjacent conductive lines of the at least 5 adjacent conductive lines are separated by a separation distance of about an odd integer multiple of a pixel pitch of the alternating pixel display, divided by an integer greater than or equal to 2;
at least 50 percent of the at least 5 adjacent conductive lines of the first plurality of conductive lines are pseudo-chromatic conductive lines adapted to cover at least a portion of each of the plurality of sub-pixel colors; and
the pseudo-chromatic conductive lines, collectively, cover substantially equal amounts (within about 33% of each other or less) of each of the plurality of sub-pixel colors.

4. The apparatus of claim 1, wherein:
intersections of the first plurality of conductive lines and the at least two of the second plurality of conductive lines form at least one substantially quadrilateral shape; and
an aspect ratio of the at least one substantially quadrilateral shape is between about 2:1 and about 0.7:1.

5. The apparatus of claim 1, wherein:
adjacent conductive lines of the first plurality of conductive lines are separated by a separation distance; and
the separation distance is greater than or less than about an integer multiple of a pixel pitch of the alternating pixel display.

6. The apparatus of claim 5, wherein:
intersections of the first plurality of conductive lines and the at least two of the second plurality of conductive lines form at least one substantially quadrilateral shape;
a first substantially quadrilateral shape from among the at least one substantially quadrilateral shape comprises four vertices; and
a furthest distance between any two of the four vertices is between about 260 micrometers and about 340 micrometers.

7. The apparatus of claim 1, further comprising a second conductive layer of a touch sensor, the second conductive layer comprising a second mesh of conductive lines layered above or below the first mesh, the second mesh comprising:
a third periodic series of conductive lines comprising a third plurality of conductive lines; and
a fourth periodic series of conductive lines comprising a fourth plurality of conductive lines;
the third plurality of conductive lines intersecting at least two of the fourth plurality of conductive lines; and
a third conductive line and an adjacent fourth conductive line of the third plurality of conductive lines comprising:
an at least bi-chromatic conductive line adapted to cover at least a portion of two sub-pixel colors of the plurality of sub-pixel colors of the plurality of sub-pixels of the alternating pixel display; and
another conductive line that, collectively with the at least bi-chromatic conductive line, are adapted to cover at least a portion of each sub-pixel color of the plurality of sub-pixel colors of the plurality of sub-pixels of the alternating pixel display.

8. The apparatus of claim 7, wherein:
intersections of the first plurality of conductive lines and the at least two of the second plurality of conductive lines form a first at least one substantially quadrilateral shape;
intersections of the third plurality of conductive lines and the at least two of the fourth plurality of conductive lines form a second at least one substantially quadrilateral shape;
a first substantially quadrilateral shape from among the first at least one substantially quadrilateral shape comprises four vertices;
a second substantially quadrilateral shape from among the second at least one substantially quadrilateral shape comprises four vertices;
for the first substantially quadrilateral shape, a furthest distance between any two of the four vertices is between about 520 micrometers and about 680 micrometers; and
for the second substantially quadrilateral shape, a furthest distance between any two of the four vertices is between about 520 micrometers and about 680 micrometers.

9. The apparatus of claim 7, wherein:
intersections of the first plurality of conductive lines and the at least two of the second plurality of conductive lines form a first at least one substantially quadrilateral shape;
intersections of the third plurality of conductive lines and the at least two of the fourth plurality of conductive lines form a second at least one substantially quadrilateral shape;
the first at least one substantially quadrilateral shape comprises four vertices;
the second at least one substantially quadrilateral shape comprises four vertices;
the first and second meshes are layered such that a plurality of the vertices of the first at least one substantially quadrilateral shape are located within an about 30 micrometer radius of the center of the second at least one substantially quadrilateral shape; and
the first and second meshes are layered such that a plurality of the vertices of the second at least one substantially quadrilateral shape are located within an about 30 micrometer radius of the center of the first at least one substantially quadrilateral shape.

10. An apparatus comprising:
a plurality of sub-pixels of an alternating pixel display arranged according to an alternating pixel display pattern, each sub-pixel corresponding to a particular sub-pixel color of a plurality of sub-pixel colors; and
a first conductive layer of a touch sensor, the first conductive layer comprising a first mesh of conductive lines, the first mesh comprising:
a first periodic series of conductive lines comprising a first plurality of conductive lines; and
a second periodic series of conductive lines comprising a second plurality of conductive lines;
the first plurality of conductive lines intersecting at least two of the second plurality of conductive lines; and
a first conductive line and an adjacent second conductive line of the first plurality of conductive lines comprising:
an at least bi-chromatic conductive line that covers at least a portion of two sub-pixel colors of the plurality of sub-pixel colors of the plurality of sub-pixels of the alternating pixel display; and
another conductive line that, collectively with the at least bi-chromatic conductive line, cover at least a portion of each sub-pixel color of the plurality of sub-pixel colors of the plurality of sub-pixels of the alternating pixel display.

11. The apparatus of claim 10, wherein the plurality of sub-pixel colors comprises red, blue, and green.

12. The apparatus of claim 10, wherein:
the first plurality of conductive lines comprise at least 5 adjacent conductive lines;
adjacent conductive lines of the at least 5 adjacent conductive lines are separated by a separation distance of about an odd integer multiple of a pixel pitch of the alternating pixel display, divided by an integer greater than or equal to 2;
at least 50 percent of the at least 5 adjacent conductive lines of the first plurality of conductive lines are pseudo-chromatic conductive lines adapted to cover at least a portion of each of the plurality of sub-pixel colors; and
the pseudo-chromatic conductive lines, collectively, cover substantially equal amounts (within about 33% of each other or less) of each of the plurality of sub-pixel colors.

13. The apparatus of claim 10, wherein:
intersections of the first plurality of conductive lines and the at least two of the second plurality of conductive lines form at least one substantially quadrilateral shape; and
an aspect ratio of the at least one substantially quadrilateral shape is between about 2:1 and about 0.7:1.

14. The apparatus of claim 10, wherein:
adjacent conductive lines of the first plurality of conductive lines are separated by a separation distance; and
the separation distance is greater or less than about an integer multiple of a pixel pitch of the alternating pixel display pattern.

15. The apparatus of claim 14, wherein:
intersections of the first plurality of conductive lines and the at least two of the second plurality of conductive lines form at least one substantially quadrilateral shape;
a substantially quadrilateral shape from among the at least one substantially quadrilateral shape comprises four vertices; and
a furthest distance between any two of the four vertices is between about 260 micrometers and about 340 micrometers.

16. The apparatus of claim 10, further comprising:
a second conductive layer of a touch sensor, the second conductive layer comprising a second mesh of conductive lines layered above or below the first mesh, the second mesh comprising:
a third periodic series of conductive lines comprising a third plurality of conductive lines; and
a fourth periodic series of conductive lines comprising a fourth plurality of conductive lines;
the third plurality of conductive lines intersecting at least two of the fourth plurality of conductive lines; and
a third conductive line and an adjacent fourth conductive line of the third plurality of conductive lines comprising:
an at least bi-chromatic conductive line that covers at least a portion of two sub-pixel colors of the plurality of sub-pixel colors of the plurality of sub-pixels of the alternating pixel display; and
another conductive line that, collectively with the at least bi-chromatic conductive line, cover at least a portion of each sub-pixel color of the plurality of sub-pixel colors of the plurality of sub-pixels of the alternating pixel display.

17. The apparatus of claim 16, wherein:
adjacent conductive lines of the third plurality of conductive lines are separated by a separation distance; and
the separation distance is greater than or less than about an integer multiple of a pixel pitch of the alternating pixel display pattern.

18. The apparatus of claim 16, wherein:
intersections of the first plurality of conductive lines and the at least two of the second plurality of conductive lines form a first at least one substantially quadrilateral shape;
intersections of the third plurality of conductive lines and the at least two of the fourth plurality of conductive lines form a second at least one substantially quadrilateral shape;
a first substantially quadrilateral shape from among the first at least one substantially quadrilateral shape comprises four vertices;
a second substantially quadrilateral shape from among the second at least one substantially quadrilateral shape comprises four vertices;
for the first substantially quadrilateral shape, a furthest distance between any two of the four vertices is between about 520 micrometers and about 680 micrometers; and
for the second substantially quadrilateral shape, a furthest distance between any two of the four vertices is between about 520 micrometers and about 680 micrometers.

19. The apparatus of claim 16, wherein:
intersections of the first plurality of conductive lines and the at least two of the second plurality of conductive lines form a first at least one substantially quadrilateral shape;
intersections of the third plurality of conductive lines and the at least two of the fourth plurality of conductive lines form a second at least one substantially quadrilateral shape;
the first at least one substantially quadrilateral shape comprises four vertices;
the second at least one substantially quadrilateral shape comprises four vertices;
the first and second meshes are layered such that a plurality of the vertices of the first at least one substantially quadrilateral shape are located within an about 30 micrometer radius of the center of the second at least one substantially quadrilateral shape; and
the first and second meshes are layered such that a plurality of the vertices of the second at least one substantially quadrilateral shape are located within an about 30 micrometer radius of the center of the first at least one substantially quadrilateral shape.

20. A method comprising:
forming, on a substrate, a first periodic series of conductive lines comprising a first plurality of conductive lines; and
forming, on the substrate, a second periodic series of conductive lines comprising a second plurality of conductive lines;
the first plurality of conductive lines intersecting at least two of the second plurality of conductive lines to form a first mesh of conductive lines of a first conductive layer of a touch sensor; and
a first conductive line and an adjacent second conductive line of the first plurality of conductive lines comprising:
an at least bi-chromatic conductive line adapted to cover at least a portion of two sub-pixel colors of a plurality of sub-pixel colors of a plurality of sub-pixels of an alternating pixel display, the plurality of sub-pixels being arranged according to an alternating pixel display pattern, each sub-pixel corresponding to a particular sub-pixel color of the plurality of sub-pixel colors; and
another conductive line that, collectively with the at least bi-chromatic conductive line, are adapted to cover at least a portion of each sub-pixel color of the plurality of sub-pixel colors of the plurality of sub-pixels of the alternating pixel display.
